(19) United States
(12) Patent Application Publication
(10) Pub. No.: US 2026/0075615 A1
(43) Pub. Date: Mar. 12, 2026

(54) ON-DEMAND SIB1 TRANSMISSION

(71) Applicant: Samsung Electronics Co., Ltd., Suwon-si, Gyeonggi-do (KR)

(72) Inventors: Hongbo Si, Allen, TX (US); Anil Agiwal, McKinney, TX (US); Dalin Zhu, Allen, TX (US)

(21) Appl. No.: 19/308,964

(22) Filed: Aug. 25, 2025

Related U.S. Application Data
(60) Provisional application No. 63/693,540, filed on Sep. 11, 2024.
(60) Provisional application No. 63/696,016, filed on Sep. 18, 2024.
(60) Provisional application No. 63/696,681, filed on Sep. 19, 2024.
(60) Provisional application No. 63/734,461, filed on Dec. 16, 2024.
(60) Provisional application No. 63/767,307, filed on Mar. 5, 2025.
(60) Provisional application No. 63/798,784, filed on May 2, 2025.

(51) Int. Cl. H04W 72/23; H04B 17/318; H04W 72/0446; H04W 74/0833

(52) U.S. Cl. CPC H04W 72/23; H04B 17/328; H04W 72/0446; H04W 74/0833

(57) ABSTRACT

Methods and apparatuses for on-demand system information block (SIB) transmissions. A method of a user equipment (UE) in a wireless communication system includes transmitting a request for a first SIB, determining a first time domain window for receiving a confirmation for the request, and receiving the confirmation for the request in the first time domain window. The method further includes determining, based on the first time domain window and the confirmation for the request, a second time domain window for monitoring a physical downlink control channel (PDCCH) scheduling the first SIB, receiving the PDCCH based on the second time domain window, and receiving the first SIB.

### CROSS-REFERENCE TO RELATED AND CLAIM OF PRIORITY

The present application claims priority under 35 U.S.C. § 119 (e) to U.S. Provisional Patent Application No. 63/693,540 filed on Sep. 11, 2024; U.S. Provisional Patent Application No. 63/696,016 filed on Sep. 18, 2024; U.S. Provisional Patent Application No. 63/696,681 filed on Sep. 19, 2024; U.S. Provisional Patent Application No. 63/734,461 filed on Dec. 16, 2024; U.S. Provisional Patent Application No. 63/767,307 filed on Mar. 5, 2025; and U.S. Provisional Patent Application No. 63/798,784 filed on May 2, 2025, which are hereby incorporated by reference in their entirety.

### TECHNICAL FIELD

The present disclosure relates generally to wireless communication systems and, more specifically, the present disclosure relates to methods and apparatuses for on-demand system information block (SIB) transmissions.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to on-demand SIB1 transmissions.

In one embodiment, a base station (BS) in a wireless communication system is provided. The BS includes a transceiver configured to receive a request for a first system information block and a processor operably coupled to the transceiver. The processor is configured to determine a first time domain window for transmitting a confirmation for the request. The transceiver is further configured to transmit the confirmation for the request in the first time domain window. The processor is further configured to determine, based on the first time domain window and the confirmation for the request, a second time domain window for monitoring a physical downlink control channel (PDCCH) scheduling the first system information block. The transceiver is further configured to transmit the PDCCH in the second time domain window and transmit the first system information block.

In another embodiment, a user equipment (UE) in a wireless communication system is provided. The UE includes a transceiver configured to transmit a request for a first system information block and a processor operably coupled to the transceiver. The processor is configured to determine a first time domain window for receiving a confirmation for the request. The transceiver is further configured to receive the confirmation for the request in the first time domain window. The processor is further configured to determine, based on the first time domain window and the confirmation for the request, a second time domain window for monitoring a PDCCH scheduling the first system information block. The transceiver is further configured to receive the PDCCH based on the second time domain window and receive the first system information block.

In yet another embodiment, a method of a UE in a wireless communication system is provided. The method includes transmitting a request for a first system information block, determining a first time domain window for receiving a confirmation for the request, and receiving the confirmation for the request in the first time domain window. The method further includes determining, based on the first time domain window and the confirmation for the request, a second time domain window for monitoring a PDCCH scheduling the first system information block, receiving the PDCCH based on the second time domain window, and receiving the first system information block.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5 illustrates examples of on-demand SIB one (SIB1) transmissions according to embodiments of the present disclosure;

FIG. 6 illustrates an example on-demand SIB1 transmission time instance according to embodiments of the present disclosure;

FIG. 7 illustrates a flowchart of an example UE procedure for receiving an on-demand SIB1 transmission according to embodiments of the present disclosure;

FIG. 8 illustrates an example PDCCH monitoring time instance according to embodiments of the present disclosure;

FIG. 9 illustrates a flowchart of an example UE procedure for receiving Type0-PDCCH and on-demand SIB1 according to embodiments of the present disclosure;

FIG. 10 illustrates an example indication/trigger for on-demand synchronization signal block (SSB) transmissions according to embodiments of the present disclosure;

FIG. 11 illustrates an example indication/trigger for layer 1 (L1) measurements according to embodiments of the present disclosure;

FIG. 12 illustrates a flowchart of an example UE procedure for L1 measurements according to embodiments of the present disclosure; and

FIG. 13 illustrates an example method performed by a UE in a wireless communication system according to embodiments of the present disclosure.

### DETAILED DESCRIPTION

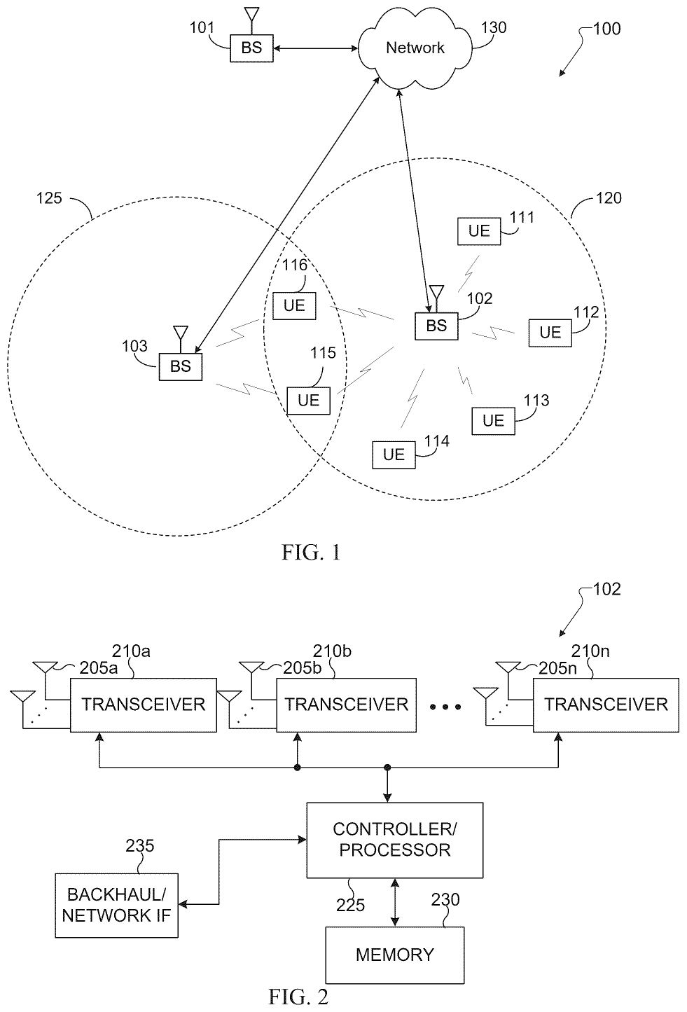

FIGS. 1-13, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v17.1.0, “NR; Physical channels and modulation;” [REF 2] 3GPP TS 38.212 v17.1.0, “NR; Multiplexing and channel coding;” [REF 3] 3GPP TS 38.213 v17.1.0, “NR; Physical layer procedures for control;” [REF 4] 3GPP TS 38.214 v17.1.0, “NR; Physical layer procedures for data;” and [REF 5] 3GPP TS 38.331 v17.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to receive on-demand SIB transmissions. In certain embodiments, one or more of the BSs 101-103 include circuitry, programing, or a combination thereof to support on-demand SIB transmissions.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as on-demand SIB transmissions. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

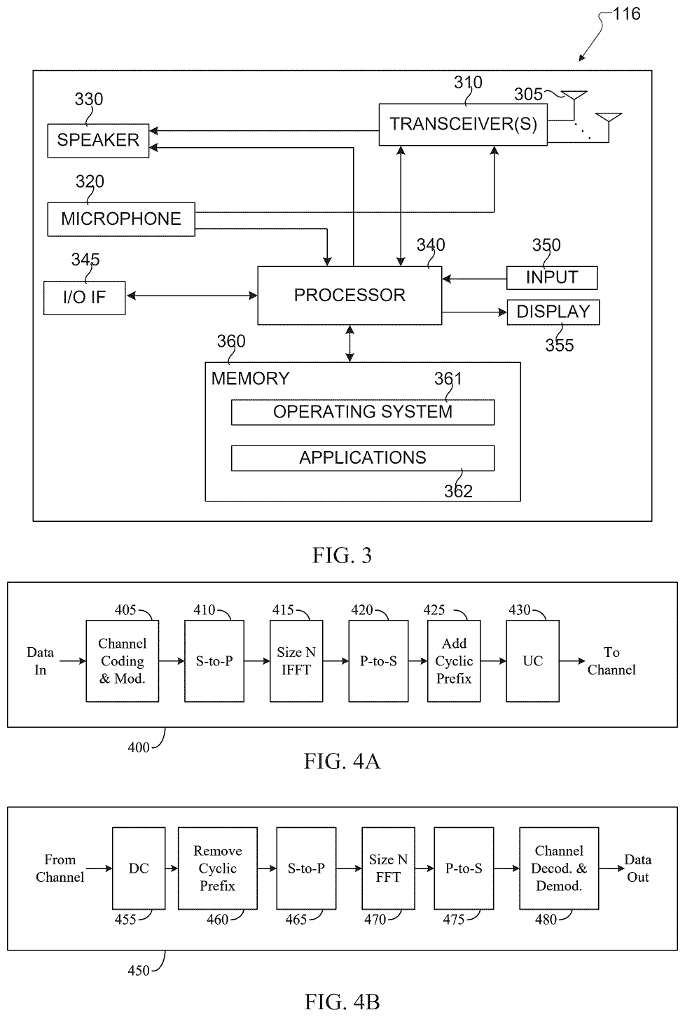

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to control reception of adapted SIB transmissions as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

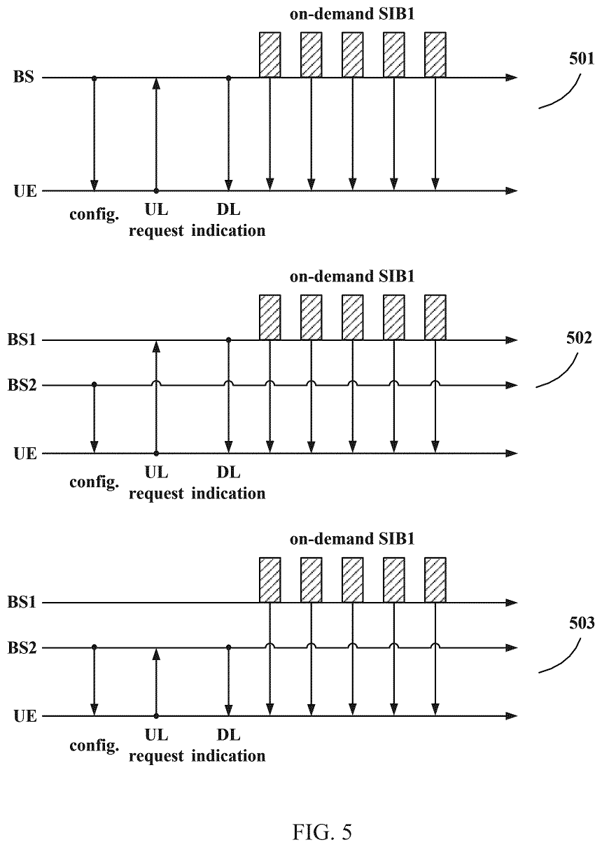

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to support on-demand SIB transmissions as described in embodiments of the present disclosure. In some embodiments, the receive path 450 is configured to support on-demand SIB transmissions as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

FIG. 5 illustrates examples of on-demand SIB1 transmissions 501, 502, and 503, respectively, according to embodiments of the present disclosure. For example, on-demand SIB1 transmissions 501, 502, and 503, respectively, can be transmitted by the BS 102 and received by any of the UEs 111-116 of FIG. 1. This example is for illustration only and other embodiments can be used without departing from the scope of the present disclosure.

In NR, for a cell with cell-defining synchronization signal/physical broadcast channel (SS/PBCH) block, a control resource set (CORESET) for monitoring type 0 physical downlink control channel (Type0-PDCCH) can be present, and the Type0-PDCCH can schedule a physical downlink shared channel (PDSCH) carrying system information block 1 (SIB1). The monitoring occasion for the Type0-PDCCH can be periodic, which is 20 ms for a first SS/PBCH block and CORESET multiplexing pattern, and same as the periodicity of the SS/PBCH block for a second and a third SS/PBCH block and CORESET multiplexing pattern. Embodiments of the present disclosure recognize that the periodic transmission and reception of Type0-PDCCH and/or PDSCH of SIB1 may consume the energy from both the BS (e.g., the BS 102) and the UE, and on-demand transmission and reception of Type0-PDCCH and/or PDSCH of SIB1 is needed to resolve the energy consumption issue.

For example, on-demand SIB1(s) can be requested by a UE using an UL request, wherein the UL request can also be denoted as uplink wake-up-signal (UL WUS), and its configuration (potentially with other configurations) can be provided by a BS; and upon a confirmation from a BS by receiving a downlink (DL) indication, the UE can expect to receive PDCCH and/or PDSCH of SIB1. An illustration of a general procedure for the on-demand SIB1 is shown in FIG. 5, wherein multiple BSs can be involved in some example procedures (e.g., 502 and 503 of FIG. 5) to provide the configuration of UL WUS, and to receive UL WUS and transmit DL indication.

This disclosure includes the design details on the adaptation of the on-demand SIB1 transmission. For one instance, the on-demand SIB1 can be supported for RRC_IDLE and/or RRC_INACTIVE UEs. For another instance, the support of on-demand SIB1 may also impact the UEs in RRC_CONNECTED within the same cell which supports on-demand SIB1 for RRC_IDLE and/or RRC_INACTIVE UEs, and for one further consideration, the UEs in RRC_CONNECTED can follow same procedure for on-demand SIB1 operation.

For one example, the UL WUS can be a physical random access channel (PRACH).

For another example, the DL indication can be a random access response (RAR) in response to a PRACH.

For yet another example, the configuration can be provided by a system information block (e.g., SIBx, where x≥1).

This disclosure focuses on adaptation of on-demand SIB1 transmission. More precisely, the following aspects are included in the disclosure:
A general framework for adaptation of on-demand SIB1 transmission
Adaptation of k_SSB with on-demand SIB1 transmission
Adaptation of indication of cell barring information with on-demand SIB1 transmission
Adaptation of indication of subcarrier spacing with on-demand SIB1 transmission
Adaptation of reserved field or bit with on-demand SIB1 transmission

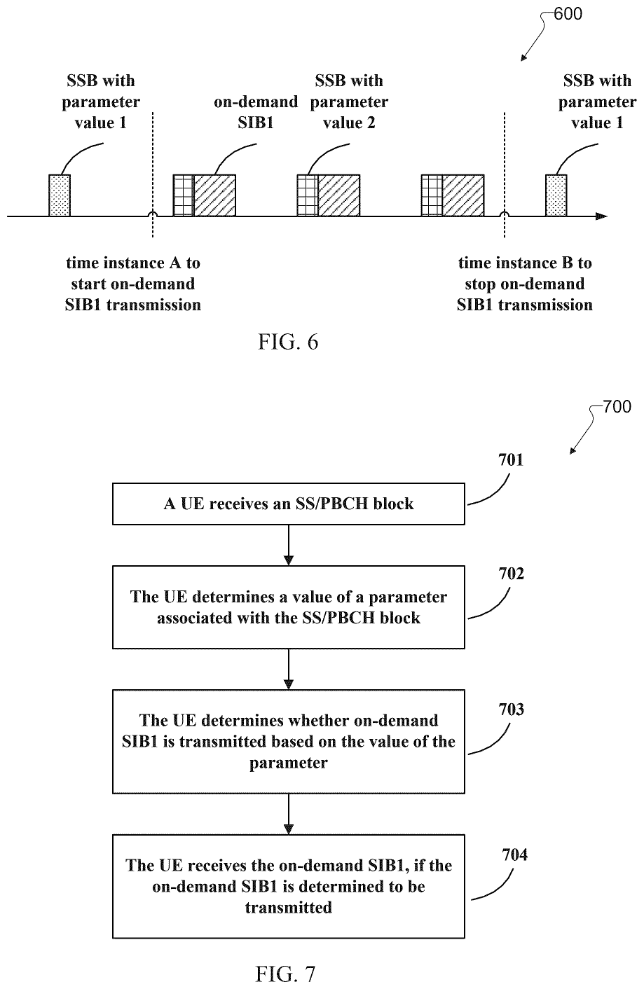

FIG. 6 illustrates an example on-demand SIB1 transmission time instance 600 according to embodiments of the present disclosure. For example, on-demand SIB1 transmission time instance 600 can be determined by any of the UEs 111-116 of FIG. 1, such as the UE 111. This example is for illustration only and other embodiments can be used without departing from the scope of the present disclosure.

In one embodiment, a transmission of on-demand SIB1 can be adapted in the time domain.

For one example, a UE (e.g., the UE 116) can determine a time instance A such that on-demand SIB1 transmissions occur after time instance A.

For another example, the UE can determine a time instance B such that on-demand SIB1 transmissions terminate at time instance B and no on-demand SIB1 transmissions occur after time instance B. For one further instance, for some example procedures, the time instance B is absent, which means the on-demand SIB1 transmission can occur without a termination time instance.

For one example, when the transmission of on-demand SIB1 is adapted in the time domain, at least one parameter associated with a SS/PBCH block can be adapted accordingly. A first value of a parameter of the SS/PBCH block can be associated with the status of no on-demand SIB1 transmission (e.g., before time instance A or after time instance B), and/or a second value of the parameter of the SS/PBCH block can be associated with the status of on-going on-demand SIB1 transmission (e.g., after time instance A and before time instance B). The first value and the second value can be different, e.g., determined from two set of values without overlapping. An illustration of the example is shown in FIG. 6.

For one example, when a UE receives a SS/PBCH block and determines a value of the parameter associated with the SS/PBCH block, if the value corresponds to the first value, the UE can determine the on-demand SIB1 transmission is not performed; if the value corresponds to the second value, the UE can determine the on-demand SIB1 transmission is performed.

For one example, the parameter of the SS/PBCH block for adaptation can be included in a payload of PBCH, e.g., at least one of a k_{SSB} value associated with the SS/PBCH block, and/or a field indicating cell barring information in master information block (MIB) within the SS/PBCH block, and/or a reserved field or bit in the PBCH payload of the SS/PBCH block, and/or a field indicating a subcarrier spacing in MIB within the SS/PBCH block.
For one instance, for FR1, the k_{SSB} value can be determined based on a combination of a field in MIB (e.g., ssb-SubcarrierOffset) and a PHY layer bit in PBCH payload (e.g., ā_{Ā+5}).
For another instance, for FR2, the k_{SSB} value can be determined based on a field in MIB, e.g., ssb-SubcarrierOffset.
For yet another instance, the field indicating cell barring information in MIB can be “cellBarred”.
For yet another instance, the reserved field in MIB can be “spare”.
For yet another instance, the reserved bit in PBCH payload can be a PHY layer bit.
For yet another instance, the field indicating a subcarrier spacing in MIB can be “subCarrierSpacingCommon”.

For another example, the parameter of the SS/PBCH block for adaptation can be included in a first sequence of primary synchronization signal (PSS) and/or a second sequence of secondary synchronization signal (SSS).
For one instance, the parameter can be based on an initial condition of the first and/or the second sequence.
For another instance, the parameter can be based on at least one cyclic shift of the first and/or the second sequence.

FIG. 7 illustrates a flowchart of an example UE procedure 700 for receiving an on-demand SIB1 transmission according to embodiments of the present disclosure. For example, procedure 700 can be performed by any of the UEs 111-116 of FIG. 1, such as the UE 112. This example is for illustration only and other embodiments can be used without departing from the scope of the present disclosure.

The procedure begins in 701, a UE received a SS/PBCH block. In 702, the UE determines a value of a parameter associated with the SS/PBCH block. In 703, the UE determines whether on-demand SIB1 is transmitted based on the value of the parameter. In 704, the UE receives the on-demand SIB1 if the on-demand SIB1 is determined to be transmitted.

An example UE procedure for the adaptation of on-demand SIB1 transmission is shown in FIG. 7.

In one embodiment, the parameter of the SS/PBCH block for adaptation can include a k_{SSB} value associated with the SS/PBCH block. For one example, when on-demand SIB1 is not transmitted on the cell, the k_{SSB} value of the associated SS/PBCH block can take a value from {24, . . . , 31} for FR1 or from {12, . . . , 15} for FR2. For another example, when on-demand SIB1 is transmitted on the cell, the k_{SSB} value of the associated SS/PBCH block can take a value from {0, . . . , 23} for FR1 or from {0, . . . , 11} for FR2.

For one instance, when the k_{SSB} associated with the received SSB takes a value from {24, . . . , 31} for FR1 or from {12, . . . , 15} for FR2, a UE supporting the feature of on-demand SIB1 can determine on-demand SIB1 transmission associated with the received SSB is not performed.

For another instance, when the k_{SSB} associated with the received SSB takes a value from {24, . . . , 31} for FR1 or from {12, . . . , 15} for FR2, a UE supporting the feature of on-demand SIB1 can determine the cell has no periodic SIB1 transmission associated with the received SSB.

For yet another instance, for FR1, when the k_{SSB} associated with the received SSB takes a value from {24, . . . , 29}, a UE supporting the feature of on-demand SIB1 can determine a frequency location of a (nearest) SSB that the cell associated with the SSB provides a configuration for at least the UL WUS (e.g., potentially also including configuration for DL indication and/or SIB1 transmission). Denoting the global synchronization channel number (GSCN) of the received SSB as

$${N}_{GSCN}^{Reference} ,$$

and denoting the GSCN of the SSB associated with the cell that provides a configuration for at least the UL WUS as

$${N}_{GSCN}^{Target} ,$$

then

$${N}_{GSCN}^{Target} = {N}_{GSCN}^{Reference} + {N}_{GSCN}^{Offset} ,$$

and the

$${N}_{GSCN}^{Offset}$$

is provided in Table 1.

TABLE 1
Mapping between the combination of k_{SSB} and controlResourceSetZero
$and searchSpaceZero to {N}_{GSCN}^{Offset} in FR 1$

| k_{SSB} | 16 × controlResourceSetZero + searchSpaceZero | ${N}_{GSCN}^{Offset}$ |
|---|---|---|
| 24 | 0, 1, . . . , 255 | 1, 2, . . . , 256 |
| 25 | 0, 1, . . . , 255 | 257, 258, . . . , 512 |
| 26 | 0, 1, . . . , 255 | 513, 514, . . . . , 768 |
| 27 | 0, 1, . . . , 255 | −1, −2, . . . , −256 |
| 28 | 0, 1, . . . , 255 | −257, −258, . . . , −512 |
| 29 | 0, 1, . . . , 255 | −513, −514, . . . , −768 |

For yet another instance, for FR2, when the k_{SSB} associated with the received SSB takes a value from {12, 13}, a UE supporting the feature of on-demand SIB1 can determine a frequency location of a (nearest) SSB that the cell associated with the SSB provides a configuration for at least the UL WUS (e.g., potentially also including configuration for DL indication and/or SIB1 transmission). Denoting the GSCN of the received SSB as

$${N}_{GSCN}^{Reference} ,$$

and denoting the GSCN of the SSB associated with the cell that provides a configuration for at least the UL WUS as

$${N}_{GSCN}^{Target} ,$$

then

$${N}_{GSCN}^{Target} = {N}_{GSCN}^{Reference} + {N}_{GSCN}^{Offset} ,$$

and the

$${N}_{GSCN}^{Offset}$$

is provided in Table 2.

TABLE 2
Mapping between the combination of k_{SSB} and controlResourceSetZero
$and searchSpaceZero to {N}_{GSCN}^{Offset} in FR 2$

| k_{SSB} | 16 × controlResourceSetZero + search SpaceZero | ${N}_{GSCN}^{Offset}$ |
|---|---|---|
| 12 | 0, 1, . . . , 255 | 1, 2, . . . , 256 |
| 13 | 0, 1, . . . , 255 | −1, −2, . . . , −256 |

For yet another instance, when the k_{SSB} associated with the received SSB takes a value from {31} for FR1 or from {15} for FR2, a UE supporting the feature of on-demand SIB1 can determine a frequency range without a SSB that the cell associated with the SSB provides a configuration for at least the UL WUS (e.g., potentially also including configuration for DL indication and/or SIB1 transmission). Denoting the GSCN of the received SSB as

$${N}_{GSCN}^{Reference} ,$$

then the UE can determine no SSB that the cell associated with the SSB provides a configuration exists within the range

$$[ {N}_{GSCN}^{Reference} - {N}_{GSCN}^{Start} , {N}_{GSCN}^{Reference} + {N}_{GSCN}^{End} ] ,$$

and

$${N}_{GSCN}^{Start}$$

and

$${N}_{GSCN}^{End}$$

are provided by controlResourceSetZero and searchSpaceZero, respectively.

For yet another instance, when the k_{SSB} associated with the received SSB takes from {0, . . . , 23} for FR1 or from {0, . . . , 11} for FR2, a UE supporting the feature of on-demand SIB1 can determine a common resource grid using the value of k_{SSB}.

For yet another instance, when the k_{SSB} associated with the received SSB takes from {0, . . . , 23} for FR1 or from {0, . . . , 11} for FR2, a UE supporting the feature of on-demand SIB1 can determine a CORESET for monitoring Type0-PDCCH is present. For one further instance, the configuration for CORESET can be provided by controlResourceSetZero (e.g., provided by the received SSB, or by the configuration for at least the UL WUS, or by the DL indication). For another further instance, the configuration for search space set to monitor Type0-PDCCH can be provided by searchSpaceZero (e.g., provided by the received SSB, or by the configuration for at least the UL WUS, or by the DL indication). For yet another further instance, the configuration for subcarrier spacing can be provided by subCarrierSpacingCommon (e.g., provided by the received SSB, or by the configuration for at least the UL WUS, or by the DL indication).

For yet another instance, a UE supporting the feature of on-demand SIB1 can determine whether the cell is barred or not based on an indication in system information (e.g., SIB1).

For yet another instance, a UE supporting the feature of on-demand SIB1 can determine whether the cell is barred or not based on an indication in PBCH payload of the received SSB (e.g., the field of cellBarred in MIB, a reserved field in MIB, or a reserved PHY bit in the PBCH payload).

For yet another instance, when the k_{SSB} associated with the received SSB takes a value from {24, . . . , 31} for FR1 or from {12, . . . , 15} for FR2, a UE not supporting the feature of on-demand SIB1 can determine CORESET for monitoring Type0-PDCCH is not present in the cell associated with the received SSB.

For yet another instance, when the k_{SSB} associated with the received SSB takes from {0, . . . , 23} for FR1 or from {0, . . . , 11} for FR2, a UE not supporting the feature of on-demand SIB1 can determine a common resource grid using the value of k_{SSB}.

For yet another instance, when the k_{SSB} associated with the received SSB takes from {0, . . . , 23} for FR1 or from {0, . . . , 11} for FR2, a UE not supporting the feature of on-demand SIB1 can determine a CORESET for monitoring Type0-PDCCH is present. For one further instance, the configuration for CORESET can be provided by controlResourceSetZero (e.g., provided by the received SSB). For another further instance, the configuration for search space set to monitor Type0-PDCCH can be provided by searchSpaceZero (e.g., provided by the received SSB). For yet another further instance, the configuration for subcarrier spacing can be provided by subCarrierSpacingCommon (e.g., provided by the received SSB).

For yet another instance, when the k_{SSB} associated with the received SSB takes from {0, . . . , 23} for FR1 or from {0, . . . , 11} for FR2, a UE not supporting the feature of on-demand SIB1 can determine whether the cell is barred or not based on an indication in MIB of the received SSB (e.g., cellBarred), and/or based on an indication in SIB1.

For yet another instance, a UE not supporting the feature of on-demand SIB1 expects the cell is barred based on an indication in MIB of the received SSB (e.g., cellBarred). For one further instance, this instance can be applicable when the k_{SSB} associated with the received SSB takes from {0, . . . , 23} for FR1 or from {0, . . . , 11} for FR2.

For yet another instance, a UE not supporting the feature of on-demand SIB1 expects the cell is barred based on an indication in SIB1. For one further instance, this instance can be applicable when the k_{SSB} associated with the received SSB takes from {0, . . . , 23} for FR1 or from {0, . . . , 11} for FR2.

For yet another instance, if a UE supporting the feature of on-demand SIB1 determines a k_{SSB} value is from {24, . . . , 31} for FR1 or from {12, . . . , 15} for FR2, the UE can send the UL WUS to a base station to request the on-demand SIB1.

For yet another instance, if a UE supporting the feature of on-demand SIB1 determines a k_{SSB} value is from {0, . . . , 23} for FR1 or from {0, . . . , 11} for FR2, the UE may not send the UL WUS to a base station to request the on-demand SIB1.

In one embodiment, the parameter of the SS/PBCH block for adaptation can include a k_{SSB} value associated with the SS/PBCH block. For one example, when on-demand SIB1 is not transmitted on the cell, the k_{SSB} value of the associated SS/PBCH block can take a value from {24, . . . , 29, 31} for FR1 or from {12, 13, 15} for FR2. For another example, when on-demand SIB1 is transmitted on the cell, the k_{SSB} value of the associated SS/PBCH block can take a value from {30} for FR1 or from {14} for FR2.

For one instance, when the k_{SSB} associated with the received SSB takes a value from {24, . . . , 29, 31} for FR1 or from {12, 13, 15} for FR2, a UE supporting the feature of on-demand SIB1 can determine on-demand SIB1 transmission associated with the received SSB is not performed.

For another instance, when the k_{SSB} associated with the received SSB takes a value from {24, . . . , 29, 31} for FR1 or from {12, 13, 15} for FR2, a UE supporting the feature of on-demand SIB1 can determine the cell has no periodic SIB1 transmission associated with the received SSB.

For yet another instance, for FR1, when the k_{SSB} associated with the received SSB takes a value from {24, . . . , 29}, a UE supporting the feature of on-demand SIB1 can determine a frequency location of a (nearest) SSB that the cell associated with the SSB provides a configuration for at least the UL WUS (e.g., potentially also including configuration for DL indication and/or SIB1 transmission). Denoting the GSCN of the received SSB as

$${N}_{GSCN}^{Reference} ,$$

and denoting the GSCN of the SSB associated with the cell that provides a configuration for at least the UL WUS as

$${N}_{GSCN}^{Target} ,$$

then

$${N}_{GSCN}^{Target} = {N}_{GSCN}^{Reference} + {N}_{GSCN}^{Offset} ,$$

and the

$${N}_{GSCN}^{Offset}$$

is provided in Table 1.

For yet another instance, for FR2, when the k_{SSB} associated with the received SSB takes a value from {12, 13}, a UE supporting the feature of on-demand SIB1 can determine a frequency location of a (nearest) SSB that the cell associated with the SSB provides a configuration for at least the UL WUS (e.g., potentially also including configuration for DL indication and/or SIB1 transmission). Denoting the GSCN of the received SSB as

$${N}_{GSCN}^{Reference} ,$$

and denoting the GSCN of the SSB associated with the cell that provides a configuration for at least the UL WUS as

$${N}_{GSCN}^{Target} ,$$

then

$${N}_{GSCN}^{Target} = {N}_{GSCN}^{Reference} + {N}_{GSCN}^{Offset} ,$$

and the

$${N}_{GSCN}^{Offset}$$

is provided in Table 2.

For yet another instance, when the k_{SSB} associated with the received SSB takes a value from {31} for FR1 or from {15} for FR2, a UE supporting the feature of on-demand SIB1 can determine a frequency range without a SSB that the cell associated with the SSB provides a configuration for at least the UL WUS (e.g., potentially also including configuration for DL indication and/or SIB1 transmission). Denoting the GSCN of the received SSB as

$${N}_{GSCN}^{Reference} ,$$

then the UE can determine no SSB that the cell associated with the SSB provides a configuration exists within the range

$$[ {N}_{GSCN}^{Reference} - {N}_{GSCN}^{Start} , {N}_{GSCN}^{Reference} + {N}_{GSCN}^{E n d} ] ,$$

and

$${N}_{GSCN}^{Start}$$

and

$${N}_{GSCN}^{End}$$

are provided by controlResourceSetZero and searchSpaceZero, respectively.

For yet another instance, when the k_{SSB} associated with the received SSB takes a value from {31} for FR1 or from {15} for FR2, a UE supporting the feature of on-demand SIB1 can determine a common resource grid using a higher layer parameter provided by a BS (e.g., in the configuration for at least the UL WUS and/or in the DL indication).

For yet another instance, when the k_{SSB} associated with the received SSB takes a value from {31} for FR1 or from {15} for FR2, a UE supporting the feature of on-demand SIB1 can determine a CORESET for monitoring Type0-PDCCH is present. For one further instance, the configuration for CORESET can be provided by controlResourceSetZero (e.g., provided by the received SSB, or by the configuration for at least the UL WUS, or by the DL indication). For another further instance, the configuration for search space set to monitor Type0-PDCCH can be provided by searchSpaceZero (e.g., provided by the received SSB, or by the configuration for at least the UL WUS, or by the DL indication). For yet another further instance, the configuration for subcarrier spacing can be provided by subCarrierSpacingCommon (e.g., provided by the received SSB, or by the configuration for at least the UL WUS, or by the DL indication).

For yet another instance, a UE supporting the feature of on-demand SIB1 can determine whether the cell is barred or not based on an indication in system information (e.g., SIB1).

For yet another instance, a UE supporting the feature of on-demand SIB1 can determine whether the cell is barred or not based on an indication in PBCH payload of the received SSB (e.g., the field of cellBarred in MIB, or a reserved field in MIB, or a reserved PHY bit in the PBCH payload).

For yet another instance, when the k_{SSB} associated with the received SSB takes a value from {24, . . . , 29, 31} for FR1 or from {12, 13, 15} for FR2, a UE not supporting the feature of on-demand SIB1 can determine CORESET for monitoring Type0-PDCCH is not present in the cell associated with the received SSB.

For yet another instance, when the k_{SSB} associated with the received SSB takes a value from {30} for FR1 or from {14} for FR2, a UE not supporting the feature of on-demand SIB1 can determine CORESET for monitoring Type0-PDCCH is not present in the cell associated with the received SSB.

For yet another instance, a UE not supporting the feature of on-demand SIB1 can determine whether the cell is barred or not based on an indication in MIB of the received SSB (e.g., cellBarred).

For yet another instance, a UE not supporting the feature of on-demand SIB1 expects the cell is barred based on an indication in MIB of the received SSB (e.g., cellBarred).

For yet another instance, if a UE supporting the feature of on-demand SIB1 determines a k_{SSB} value is from {24, . . . , 29, 31} for FR1 or from {12, 13, 15} for FR2, the UE can send the UL WUS to a base station to request the on-demand SIB1.

For yet another instance, if a UE supporting the feature of on-demand SIB1 determines a k_{SSB} value is from {30} for FR1 or from {14} for FR2, the UE may not send the UL WUS to a base station to request the on-demand SIB1.

In one embodiment, the parameter of the SS/PBCH block for adaptation can include a k_{SSB} value associated with the SS/PBCH block. For one example, when on-demand SIB1 is not transmitted on the cell, the k_{SSB} value of the associated SS/PBCH block can take a value from {30} for FR1 or from {14} for FR2. For another example, when on-demand SIB1 is transmitted on the cell, the k_{SSB} value of the associated SS/PBCH block can take a value from {0, . . . , 23} for FR1 or from {0, . . . , 11} for FR2.

For one instance, when the k_{SSB} associated with the received SSB takes a value from {30} for FR1 or from {14} for FR2, a UE supporting the feature of on-demand SIB1 can determine on-demand SIB1 transmission associated with the received SSB is not performed.

For another instance, when the k_{SSB} associated with the received SSB takes a value from {30} for FR1 or from {14} for FR2, a UE supporting the feature of on-demand SIB1 can determine the cell has no periodic SIB1 transmission associated with the received SSB.

For yet another instance, for FR1, when the k_{SSB} associated with the received SSB takes a value from {30}, a UE supporting the feature of on-demand SIB1 can determine a frequency location of a (nearest) SSB that the cell associated with the SSB provides a configuration for at least the UL WUS (e.g., potentially also including configuration for DL indication and/or SIB1 transmission). Denoting the GSCN of the received SSB as

$${N}_{GSCN}^{Reference} ,$$

and denoting the GSCN of the SSB associated with the cell that provides a configuration for at least the UL WUS as

$${N}_{GSCN}^{Target} ,$$

then

$${N}_{GSCN}^{Target} = {N}_{GSCN}^{Reference} + {N}_{GSCN}^{Offset} ,$$

and the

$${N}_{GSCN}^{Offset}$$

is provided in Table 3-1 or Table 3-2.

TABLE 3-1
Mapping between the combination of k_{SSB} and controlResourceSetZero
$and searchSpaceZero to {N}_{GSCN}^{Offset} in FR 1$

| k_{SSB} | 16 × controlResourceSetZero + searchSpaceZero | ${N}_{GSCN}^{Offset}$ |
|---|---|---|
| 30 | 0, 1, . . . , 127 | 1, 2, . . . , 128 |
| 30 | 128, 129, . . . , 255 | −1, −2, . . . , −128 |

TABLE 3-2
Mapping between the combination of k_{SSB} and controlResourceSetZero
$and searchSpaceZero to {N}_{GSCN}^{Offset} in FR 1$

| k_{SSB} | 16 × controlResourceSetZero + searchSpaceZero | ${N}_{GSCN}^{Offset}$ |
|---|---|---|
| 30 | 0, 1, . . . , 127 | −1, −2, . . . , −128 |
| 30 | 128, 129, . . . , 255 | 1, 2, . . . , 128 |

For yet another instance, for FR2, when the k_{SSB} associated with the received SSB takes a value from {14}, a UE supporting the feature of on-demand SIB1 can determine a frequency location of a (nearest) SSB that the cell associated with the SSB provides a configuration for at least the UL WUS (e.g., potentially also including configuration for DL indication and/or SIB1 transmission). Denoting the GSCN of the received SSB as

$${N}_{GSCN}^{Reference} ,$$

and denoting the GSCN of the SSB associated with the cell that provides a configuration for at least the UL WUS as

$${N}_{GSCN}^{Target} ,$$

then

$${N}_{GSCN}^{Target} = {N}_{GSCN}^{Reference} + {N}_{GSCN}^{Offset} ,$$

and the

$${N}_{GSCN}^{Offset}$$

is provided in Table 4-1 or Table as then 4-2.

TABLE 4-1
Mapping between the combination of k_{SSB} and controlResourceSetZero
$and searchSpaceZero to {N}_{GSCN}^{Offset} in FR 2$

| k_{SSB} | 16 × controlResourceSetZero + searchSpaceZero | ${N}_{GSCN}^{Offset}$ |
|---|---|---|
| 14 | 0, 1, . . . , 127 | 1, 2, . . . , 128 |
| 14 | 128, 129, . . . , 255 | −1, −2, . . . , −128 |

TABLE 4-2
Mapping between the combination of k_{SSB} and controlResourceSetZero
$and searchSpaceZero to {N}_{GSCN}^{Offset} in FR 2$

| k_{SSB} | 16 × controlResourceSetZero + searchSpaceZero | ${N}_{GSCN}^{Offset}$ |
|---|---|---|
| 14 | 0, 1, . . . , 127 | 1, −2, . . . , −128 |
| 14 | 128, 129, . . . , 255 | 1, 2, . . . , 128 |

For yet another instance, when the k_{SSB} associated with the received SSB takes from {0, . . . , 23} for FR1 or from {0, . . . , 11} for FR2, a UE supporting the feature of on-demand SIB1 can determine a common resource grid using the value of k_{SSB}.

For yet another instance, when the k_{SSB} associated with the received SSB takes from {0, . . . , 23} for FR1 or from {0, . . . , 11} for FR2, a UE supporting the feature of on-demand SIB1 can determine a CORESET for monitoring Type0-PDCCH is present. For one further instance, the configuration for CORESET can be provided by controlResourceSetZero (e.g., provided by the received SSB, or by the configuration for at least the UL WUS, or by the DL indication). For another further instance, the configuration for search space set to monitor Type0-PDCCH can be provided by searchSpaceZero (e.g., provided by the received SSB, or by the configuration for at least the UL WUS, or by the DL indication). For yet another further instance, the configuration for subcarrier spacing can be provided by subCarrierSpacingCommon (e.g., provided by the received SSB, or by the configuration for at least the UL WUS, or by the DL indication).

For yet another instance, a UE (e.g., the UE 116) supporting the feature of on-demand SIB1 can determine whether the cell is barred or not based on an indication in system information (e.g., SIB1).

For yet another instance, a UE supporting the feature of on-demand SIB1 can determine whether the cell is barred or not based on an indication in PBCH payload of the received SSB (e.g., the field of cellBarred in MIB, a reserved field in MIB, or a reserved PHY bit in the PBCH payload).

For yet another instance, when the k_{SSB} associated with the received SSB takes a value from {30} for FR1 or from {14} for FR2, a UE not supporting the feature of on-demand SIB1 can determine CORESET for monitoring Type0-PDCCH is not present in the cell associated with the received SSB.

For yet another instance, when the k_{SSB} associated with the received SSB takes from {0, . . . , 23} for FR1 or from {0, . . . , 11} for FR2, a UE not supporting the feature of on-demand SIB1 can determine a common resource grid using the value of k_{SSB}.

For yet another instance, when the k_{SSB} associated with the received SSB takes from {0, . . . , 23} for FR1 or from {0, . . . , 11} for FR2, a UE not supporting the feature of on-demand SIB1 can determine a CORESET for monitoring Type0-PDCCH is present. For one further instance, the configuration for CORESET can be provided by controlResourceSetZero (e.g., provided by the received SSB). For another further instance, the configuration for search space set to monitor Type0-PDCCH can be provided by searchSpaceZero (e.g., provided by the received SSB). For yet another further instance, the configuration for subcarrier spacing can be provided by subCarrierSpacingCommon (e.g., provided by the received SSB).

For yet another instance, when the k_{SSB} associated with the received SSB takes from {0, . . . , 23} for FR1 or from {0, . . . , 11} for FR2, a UE not supporting the feature of on-demand SIB1 can determine whether the cell is barred or not based on an indication in MIB of the received SSB (e.g., cellBarred), and/or based on an indication in SIB1.

For yet another instance, a UE not supporting the feature of on-demand SIB1 expects the cell is barred based on an indication in MIB of the received SSB (e.g., cellBarred). For one further instance, this instance can be applicable when the k_{SSB} associated with the received SSB takes from {0, . . . , 23} for FR1 or from {0, . . . , 11} for FR2.

For yet another instance, a UE not supporting the feature of on-demand SIB1 expects the cell is barred based on an indication in SIB1. For one further instance, this instance can be applicable when the k_{SSB} associated with the received SSB takes from {0, . . . , 23} for FR1 or from {0, . . . , 11} for FR2.

For yet another instance, if a UE supporting the feature of on-demand SIB1 determines a k_{SSB} value is from {30} for FR1 or from {14} for FR2, the UE can send the UL WUS to a base station to request the on-demand SIB1.

For yet another instance, if a UE supporting the feature of on-demand SIB1 determines a k_{SSB} value is from {0, . . . , 23} for FR1 or from {0, . . . , 11} for FR2, the UE may not send the UL WUS to a base station to request the on-demand SIB1.

In one embodiment, the parameter of the SS/PBCH block for adaptation can include an indication of cell barring information in the MIB (e.g., cellBarred). For one example, when on-demand SIB1 is not transmitted on the cell, the indication of cell barring information in the MIB (e.g., cellBarred) of the associated SS/PBCH block can take a first value (e.g., “barred”). For another example, when on-demand SIB1 is transmitted on the cell, the indication of cell barring information in the MIB (e.g., cellBarred) of the associated SS/PBCH block can take a second value (e.g., “notBarred”).

For one instance, the k_{SSB} associated with the received SSB takes a value from {24, . . . , 31} for FR1 or from {12, . . . , 15} for FR2. For one further instance, this instance is applicable for SSB with and without on-demand SIB1 transmission.

For another instance, the k_{SSB} associated with the received SSB takes a value from {30} for FR1 or from {14} for FR2. For one further instance, this instance is applicable for SSB with and without on-demand SIB1 transmission.

For yet another instance, when the indication of cell barring information in the MIB (e.g., cellBarred) of the associated SS/PBCH block takes a first value (e.g., “barred”), a UE supporting the feature of on-demand SIB1 can determine on-demand SIB1 transmission associated with the received SSB is not performed.

For yet another instance, a UE supporting the feature of on-demand SIB1 can determine the cell has no periodic SIB1 transmission associated with the received SSB.

For yet another instance, when the indication of cell barring information in the MIB (e.g., cellBarred) of the associated SS/PBCH block takes a second value (e.g., “notBarred”), a UE supporting the feature of on-demand SIB1 can determine a common resource grid using a higher layer parameter provided by a BS (e.g., the BS 102) (e.g., in the configuration for at least the UL WUS and/or in the DL indication).

For yet another instance, when the indication of cell barring information in the MIB (e.g., cellBarred) of the associated SS/PBCH block takes a second value (e.g., “notBarred”), a UE supporting the feature of on-demand SIB1 can determine a CORESET for monitoring Type0-PDCCH is present. For one further instance, the configuration for CORESET can be provided by controlResourceSetZero (e.g., provided by the received SSB, or by the configuration for at least the UL WUS, or by the DL indication). For another further instance, the configuration for search space set to monitor Type0-PDCCH can be provided by searchSpaceZero (e.g., provided by the received SSB, or by the configuration for at least the UL WUS, or by the DL indication). For yet another further instance, the configuration for subcarrier spacing can be provided by subCarrierSpacingCommon (e.g., provided by the received SSB, or by the configuration for at least the UL WUS, or by the DL indication).

For yet another instance, a UE supporting the feature of on-demand SIB1 can determine whether the cell is barred or not based on an indication in system information (e.g., SIB1).

For yet another instance, a UE supporting the feature of on-demand SIB1 can determine whether the cell is barred or not based on an indication in PBCH payload of the received SSB (e.g., a reserved field in MIB, or a reserved PHY bit in the PBCH payload).

For yet another instance, a UE not supporting the feature of on-demand SIB1 can determine CORESET for monitoring Type0-PDCCH is not present in the cell associated with the received SSB.

For yet another instance, when the indication of cell barring information in the MIB (e.g., cellBarred) of the received SS/PBCH block takes a first value (e.g., “barred”), a UE supporting the feature of on-demand SIB1 may send the UL WUS to a base station to request the on-demand SIB1.

For yet another instance, when the indication of cell barring information in the MIB (e.g., cellBarred) of the received SS/PBCH block takes a second value (e.g., “notBarred”), a UE supporting the feature of on-demand SIB1 may not send the UL WUS to a base station to request the on-demand SIB1.

In one embodiment, the parameter of the SS/PBCH block for adaptation can include an indication of cell barring information in the MIB (e.g., cellBarred). For one example, when on-demand SIB1 is not transmitted on the cell, the indication of cell barring information in the MIB (e.g., cellBarred) of the associated SS/PBCH block can take a first value (e.g., “barred”). For another example, when on-demand SIB1 is transmitted on the cell, the indication of cell barring information in the MIB (e.g., cellBarred) of the associated SS/PBCH block can take a second value (e.g., “notBarred”).

For one instance, the k_{SSB} associated with the received SSB takes a value from {0, . . . , 23} for FR1 or from {0, . . . , 11} for FR2. For one further instance, this instance is applicable for SSB with and without on-demand SIB1 transmission.

For another instance, when the indication of cell barring information in the MIB (e.g., cellBarred) of the associated SS/PBCH block takes a first value (e.g., “barred”), a UE supporting the feature of on-demand SIB1 can determine on-demand SIB1 transmission associated with the received SSB is not performed.

For yet another instance, when the indication of cell barring information in the MIB (e.g., cellBarred) of the associated SS/PBCH block takes a first value (e.g., “barred”), a UE supporting the feature of on-demand SIB1 can determine the cell has no periodic SIB1 transmission associated with the received SSB.

For yet another instance, when the indication of cell barring information in the MIB (e.g., cellBarred) of the associated SS/PBCH block takes a second value (e.g., “notBarred”), a UE supporting the feature of on-demand SIB1 can determine a common resource grid using k_{SSB}.

For yet another instance, when the indication of cell barring information in the MIB (e.g., cellBarred) of the associated SS/PBCH block takes a second value (e.g., “notBarred”), a UE supporting the feature of on-demand SIB1 can determine a CORESET for monitoring Type0-PDCCH is present. For one further instance, the configuration for CORESET can be provided by controlResourceSetZero (e.g., provided by the received SSB, or by the configuration for at least the UL WUS, or by the DL indication). For another further instance, the configuration for search space set to monitor Type0-PDCCH can be provided by searchSpaceZero (e.g., provided by the received SSB, or by the configuration for at least the UL WUS, or by the DL indication). For yet another further instance, the configuration for subcarrier spacing can be provided by subCarrierSpacingCommon (e.g., provided by the received SSB, or by the configuration for at least the UL WUS, or by the DL indication).

For yet another instance, a UE supporting the feature of on-demand SIB1 can determine whether the cell is barred or not based on an indication in system information (e.g., SIB1).

For yet another instance, a UE supporting the feature of on-demand SIB1 can determine whether the cell is barred or not based on an indication in PBCH payload of the received SSB (e.g., a reserved field in MIB, or a reserved PHY bit in the PBCH payload).

For yet another instance, when the indication of cell barring information in the MIB (e.g., cellBarred) of the associated SS/PBCH block takes a first value (e.g., “barred”), a UE not supporting the feature of on-demand SIB1 can determine the cell is barred.

For yet another instance, when the indication of cell barring information in the MIB (e.g., cellBarred) of the associated SS/PBCH block takes a second value (e.g., “notBarred”), a UE not supporting the feature of on-demand SIB1 can determine a common resource grid using k_{SSB}.

For yet another instance, when the indication of cell barring information in the MIB (e.g., cellBarred) of the associated SS/PBCH block takes a second value (e.g., “notBarred”), a UE not supporting the feature of on-demand SIB1 can determine a CORESET for monitoring Type0-PDCCH is present. For one further instance, the configuration for CORESET can be provided by controlResourceSetZero (e.g., provided by the received SSB, or by the configuration for at least the UL WUS, or by the DL indication). For another further instance, the configuration for search space set to monitor Type0-PDCCH can be provided by searchSpaceZero (e.g., provided by the received SSB, or by the configuration for at least the UL WUS, or by the DL indication). For yet another further instance, the configuration for subcarrier spacing can be provided by subCarrierSpacingCommon (e.g., provided by the received SSB, or by the configuration for at least the UL WUS, or by the DL indication).

For yet another instance, when the indication of cell barring information in the MIB (e.g., cellBarred) of the received SS/PBCH block takes a first value (e.g., “barred”), a UE supporting the feature of on-demand SIB1 may send the UL WUS to a base station to request the on-demand SIB1.

For yet another instance, when the indication of cell barring information in the MIB (e.g., cellBarred) of the received SS/PBCH block takes a second value (e.g., “notBarred”), a UE supporting the feature of on-demand SIB1 may not send the UL WUS to a base station to request the on-demand SIB1.

In one embodiment, the parameter of the SS/PBCH block for adaptation can include an indication of a subcarrier spacing in the MIB (e.g., subCarrierSpacingCommon). For one example, when on-demand SIB1 is not transmitted on the cell, the indication of a subcarrier spacing in the MIB (e.g., subCarrierSpacingCommon) of the associated SS/PBCH block can take a first value (e.g., “scs15or60”). For another example, when on-demand SIB1 is transmitted on the cell, the indication of a subcarrier spacing in the MIB (e.g., subCarrierSpacingCommon) of the associated SS/PBCH block can take a second value (e.g., “scs30or120”).

For one instance, the k_{SSB} associated with the received SSB takes a value from {24, . . . , 31} for FR1 or from {12, . . . , 15} for FR2. For one further instance, this instance is applicable for SSB with and without on-demand SIB1 transmission.

For another instance, the k_{SSB} associated with the received SSB takes a value from {30} for FR1 or from {14} for FR2. For one further instance, this instance is applicable for SSB with and without on-demand SIB1 transmission.

For yet another instance, when the indication of a subcarrier spacing in the MIB (e.g., subCarrierSpacingCommon) of the associated SS/PBCH block takes a first value, a UE supporting the feature of on-demand SIB1 can determine on-demand SIB1 transmission associated with the received SSB is not performed.

For yet another instance, a UE supporting the feature of on-demand SIB1 can determine the cell has no periodic SIB1 transmission associated with the received SSB.

For yet another instance, when the indication of a subcarrier spacing in the MIB (e.g., subCarrierSpacingCommon) of the associated SS/PBCH block takes a second value, a UE supporting the feature of on-demand SIB1 can determine a common resource grid using a higher layer parameter provided by a BS (e.g., in the configuration for at least the UL WUS and/or in the DL indication).

For yet another instance, when the indication of a subcarrier spacing in the MIB (e.g., subCarrierSpacingCommon) of the associated SS/PBCH block takes a second value (e.g., “notBarred”), a UE supporting the feature of on-demand SIB1 can determine a CORESET for monitoring Type0-PDCCH is present. For one further instance, the configuration for CORESET can be provided by controlResourceSetZero (e.g., provided by the received SSB, or by the configuration for at least the UL WUS, or by the DL indication). For another further instance, the configuration for search space set to monitor Type0-PDCCH can be provided by searchSpaceZero (e.g., provided by the received SSB, or by the configuration for at least the UL WUS, or by the DL indication). For yet another further instance, the configuration for subcarrier spacing can be provided by subCarrierSpacingCommon (e.g., provided by the received SSB, or by the configuration for at least the UL WUS, or by the DL indication).

For yet another instance, a UE supporting the feature of on-demand SIB1 can determine whether the cell is barred or not based on an indication in system information (e.g., SIB1).

For yet another instance, a UE supporting the feature of on-demand SIB1 can determine whether the cell is barred or not based on an indication in PBCH payload of the received SSB (e.g., the field of cellBarred in MIB, or a reserved field in MIB, or a reserved PHY bit in the PBCH payload).

For yet another instance, a UE not supporting the feature of on-demand SIB1 can determine CORESET for monitoring Type0-PDCCH is not present in the cell associated with the received SSB.

For yet another instance, when the indication of a subcarrier spacing in the MIB (e.g., subCarrierSpacingCommon) of the received SS/PBCH block takes a first value, a UE supporting the feature of on-demand SIB1 may send the UL WUS to a base station to request the on-demand SIB1.

For yet another instance, when the indication of a subcarrier spacing in the MIB (e.g., subCarrierSpacingCommon) of the received SS/PBCH block takes a second value, a UE supporting the feature of on-demand SIB1 may not send the UL WUS to a base station to request the on-demand SIB1.

In one embodiment, the parameter of the SS/PBCH block for adaptation can include an indication of a subcarrier spacing in the MIB (e.g., subCarrierSpacingCommon). For one example, when on-demand SIB1 is not transmitted on the cell, the indication of a subcarrier spacing in the MIB (e.g., subCarrierSpacingCommon) of the associated SS/PBCH block can take a first value (e.g., “scs15or60”). For another example, when on-demand SIB1 is transmitted on the cell, the indication of a subcarrier spacing in the MIB (e.g., subCarrierSpacingCommon) of the associated SS/PBCH block can take a second value (e.g., “scs30or120”).

For one instance, the k_{SSB} associated with the received SSB takes a value from {0, . . . , 23} for FR1 or from {0, . . . , 11} for FR2. For one further instance, this instance is applicable for SSB with and without on-demand SIB1 transmission.

For another instance, when the indication of a subcarrier spacing in the MIB (e.g., subCarrierSpacingCommon) of the associated SS/PBCH block takes a first value, a UE supporting the feature of on-demand SIB1 can determine on-demand SIB1 transmission associated with the received SSB is not performed.

For yet another instance, when the indication of a subcarrier spacing in the MIB (e.g., subCarrierSpacingCommon) of the associated SS/PBCH block takes a first value, a UE supporting the feature of on-demand SIB1 can determine the cell has no periodic SIB1 transmission associated with the received SSB.

For yet another instance, when the indication of a subcarrier spacing in the MIB (e.g., subCarrierSpacingCommon) of the associated SS/PBCH block takes a second value, a UE supporting the feature of on-demand SIB1 can determine a common resource grid using k_{SSB}.

For yet another instance, when the indication of a subcarrier spacing in the MIB (e.g., subCarrierSpacingCommon) of the associated SS/PBCH block takes a second value, a UE supporting the feature of on-demand SIB1 can determine a CORESET for monitoring Type0-PDCCH is present. For one further instance, the configuration for CORESET can be provided by controlResourceSetZero (e.g., provided by the received SSB, or by the configuration for at least the UL WUS, or by the DL indication). For another further instance, the configuration for search space set to monitor Type0-PDCCH can be provided by searchSpaceZero (e.g., provided by the received SSB, or by the configuration for at least the UL WUS, or by the DL indication). For yet another further instance, the configuration for subcarrier spacing can be provided by subCarrierSpacingCommon (e.g., provided by the received SSB, or by the configuration for at least the UL WUS, or by the DL indication).

For yet another instance, a UE supporting the feature of on-demand SIB1 can determine whether the cell is barred or not based on an indication in system information (e.g., SIB1).

For yet another instance, a UE supporting the feature of on-demand SIB1 can determine whether the cell is barred or not based on an indication in PBCH payload of the received SSB (e.g., the field of cellBarred in MIB, or a reserved field in MIB, or a reserved PHY bit in the PBCH payload).

For yet another instance, a UE not supporting the feature of on-demand SIB1 expects the cell is barred based on an indication in MIB of the received SSB (e.g., cellBarred).

For yet another instance, when the indication of a subcarrier spacing in the MIB (e.g., subCarrierSpacingCommon) of the received SS/PBCH block takes a first value, a UE supporting the feature of on-demand SIB1 may send the UL WUS to a base station to request the on-demand SIB1.

For yet another instance, when the indication of a subcarrier spacing in the MIB (e.g., subCarrierSpacingCommon) of the received SS/PBCH block takes a second value, a UE supporting the feature of on-demand SIB1 may not send the UL WUS to a base station to request the on-demand SIB1.

In one embodiment, the parameter of the SS/PBCH block for adaptation can include a reserved field or bit in the MIB (e.g., spare, or a reserved PHY layer bit). For one example, when on-demand SIB1 is not transmitted on the cell, a reserved field or bit in the MIB (e.g., spare, or a reserved PHY layer bit) of the associated SS/PBCH block can take a first value (e.g., 0). For another example, when on-demand SIB1 is transmitted on the cell, a reserved field or bit in the MIB (e.g., spare, or a reserved PHY layer bit) of the associated SS/PBCH block can take a second value (e.g., 1).

For one instance, the k_{SSB} associated with the received SSB takes a value from {24, . . . , 31} for FR1 or from {12, . . . , 15} for FR2. For one further instance, this instance is applicable for SSB with and without on-demand SIB1 transmission.

For another instance, the k_{SSB} associated with the received SSB takes a value from {30} for FR1 or from {14} for FR2. For one further instance, this instance is applicable for SSB with and without on-demand SIB1 transmission.

For yet another instance, when a reserved field or bit in the MIB (e.g., spare, or a reserved PHY layer bit) of the associated SS/PBCH block takes a first value, a UE supporting the feature of on-demand SIB1 can determine on-demand SIB1 transmission associated with the received SSB is not performed.

For yet another instance, a UE supporting the feature of on-demand SIB1 can determine the cell has no periodic SIB1 transmission associated with the received SSB.

For yet another instance, when a reserved field or bit in the MIB (e.g., spare, or a reserved PHY layer bit) of the associated SS/PBCH block takes a second value, a UE supporting the feature of on-demand SIB1 can determine a common resource grid using a higher layer parameter provided by a BS (e.g., in the configuration for at least the UL WUS and/or in the DL indication).

For yet another instance, when a reserved field or bit in the MIB (e.g., spare, or a reserved PHY layer bit) of the associated SS/PBCH block takes a second value (e.g., “notBarred”), a UE supporting the feature of on-demand SIB1 can determine a CORESET for monitoring Type0-PDCCH is present. For one further instance, the configuration for CORESET can be provided by controlResourceSetZero (e.g., provided by the received SSB, or by the configuration for at least the UL WUS, or by the DL indication). For another further instance, the configuration for search space set to monitor Type0-PDCCH can be provided by searchSpaceZero (e.g., provided by the received SSB, or by the configuration for at least the UL WUS, or by the DL indication). For yet another further instance, the configuration for subcarrier spacing can be provided by subCarrierSpacingCommon (e.g., provided by the received SSB, or by the configuration for at least the UL WUS, or by the DL indication).

For yet another instance, a UE supporting the feature of on-demand SIB1 can determine whether the cell is barred or not based on an indication in system information (e.g., SIB1).

For yet another instance, a UE supporting the feature of on-demand SIB1 can determine whether the cell is barred or not based on an indication in PBCH payload of the received SSB (e.g., the field of cellBarred in MIB, or a reserved field in MIB, or a reserved PHY bit in the PBCH payload).

For yet another instance, a UE not supporting the feature of on-demand SIB1 can determine CORESET for monitoring Type0-PDCCH is not present in the cell associated with the received SSB.

For yet another instance, when a reserved field or bit in the MIB (e.g., spare, or a reserved PHY layer bit) of the received SS/PBCH block takes a first value, a UE supporting the feature of on-demand SIB1 may send the UL WUS to a base station to request the on-demand SIB1.

For yet another instance, when the indication of a subcarrier spacing in the MIB (e.g., subCarrierSpacingCommon) of the received SS/PBCH block takes a second value, a UE supporting the feature of on-demand SIB1 may not send the UL WUS to a base station to request the on-demand SIB1.

In one embodiment, the parameter of the SS/PBCH block for adaptation can include a reserved field or bit in the MIB (e.g., spare, or a reserved PHY layer bit). For one example, when on-demand SIB1 is not transmitted on the cell, a reserved field or bit in the MIB (e.g., spare, or a reserved PHY layer bit) of the associated SS/PBCH block can take a first value (e.g., 0). For another example, when on-demand SIB1 is transmitted on the cell, a reserved field or bit in the MIB (e.g., spare, or a reserved PHY layer bit) of the associated SS/PBCH block can take a second value (e.g., 1).

For one instance, the k_{SSB} associated with the received SSB takes a value from {0, . . . , 23} for FR1 or from {0, . . . , 11} for FR2. For one further instance, this instance is applicable for SSB with and without on-demand SIB1 transmission.

For another instance, when a reserved field or bit in the MIB (e.g., spare, or a reserved PHY layer bit) of the associated SS/PBCH block takes a first value, a UE supporting the feature of on-demand SIB1 can determine on-demand SIB1 transmission associated with the received SSB is not performed.

For yet another instance, when a reserved field or bit in the MIB (e.g., spare, or a reserved PHY layer bit) of the associated SS/PBCH block takes a first value, a UE supporting the feature of on-demand SIB1 can determine the cell has no periodic SIB1 transmission associated with the received SSB.

For yet another instance, when a reserved field or bit in the MIB (e.g., spare, or a reserved PHY layer bit) of the associated SS/PBCH block takes a second value, a UE supporting the feature of on-demand SIB1 can determine a common resource grid using k_{SSB}.

For yet another instance, when the indication of a subcarrier spacing in the MIB (e.g., subCarrierSpacingCommon) of the associated SS/PBCH block takes a second value, a UE supporting the feature of on-demand SIB1 can determine a CORESET for monitoring Type0-PDCCH is present. For one further instance, the configuration for CORESET can be provided by controlResourceSetZero (e.g., provided by the received SSB, or by the configuration for at least the UL WUS, or by the DL indication). For another further instance, the configuration for search space set to monitor Type0-PDCCH can be provided by searchSpaceZero (e.g., provided by the received SSB, or by the configuration for at least the UL WUS, or by the DL indication). For yet another further instance, the configuration for subcarrier spacing can be provided by subCarrierSpacingCommon (e.g., provided by the received SSB, or by the configuration for at least the UL WUS, or by the DL indication).

For yet another instance, a UE supporting the feature of on-demand SIB1 can determine whether the cell is barred or not based on an indication in system information (e.g., SIB1).

For yet another instance, a UE (e.g., the UE 116) supporting the feature of on-demand SIB1 can determine whether the cell is barred or not based on an indication in PBCH payload of the received SSB (e.g., the field of cellBarred in MIB, or a reserved field in MIB, or a reserved PHY bit in the PBCH payload).

For yet another instance, a UE not supporting the feature of on-demand SIB1 expects the cell is barred based on an indication in MIB of the received SSB (e.g., cellBarred).

For yet another instance, when a reserved field or bit in the MIB (e.g., spare, or a reserved PHY layer bit) of the received SS/PBCH block takes a first value, a UE supporting the feature of on-demand SIB1 may send the UL WUS to a base station to request the on-demand SIB1.

For yet another instance, when a reserved field or bit in the MIB (e.g., spare, or a reserved PHY layer bit) of the received SS/PBCH block takes a second value, a UE supporting the feature of on-demand SIB1 may not send the UL WUS to a base station to request the on-demand SIB1.

In NR, for a cell with cell-defining SS/PBCH block, a CORESET for monitoring Type0-PDCCH can be present, and the Type0-PDCCH can schedule a PDSCH carrying SIB1. The monitoring occasion for the Type0-PDCCH can be periodic, which is 20 ms for a first SS/PBCH block and CORESET multiplexing pattern, and same as the periodicity of the SS/PBCH block for a second and a third SS/PBCH block and CORESET multiplexing pattern. The periodic transmission and reception of Type0-PDCCH and/or PDSCH of SIB1 may consume the energy from both the BS and the UE, and on-demand transmission and reception of Type0-PDCCH and/or PDSCH of SIB1 can be supported to resolve the energy consumption issue.

For example, on-demand SIB1(s) can be requested by a UE using an UL request, wherein the UL request can also be denoted as uplink wake-up-signal (UL WUS), and its configuration (potentially with other configurations) can be provided by a BS (e.g., the BS 102); and upon a confirmation from a BS by receiving a DL indication, the UE can expect to receive PDCCH and/or PDSCH of SIB1. An illustration of a general procedure for the on-demand SIB1 is shown in FIG. 5, wherein multiple BSs can be involved in some example procedures (e.g., 502 and 503 of FIG. 5) to provide the configuration of UL WUS, and to receive UL WUS and transmit DL indication.

This disclosure also includes the design details on the adaptation of the on-demand SIB1 transmission. For one instance, the on-demand SIB1 can be supported for RRC_IDLE and/or RRC_INACTIVE UEs. For another instance, the support of on-demand SIB1 may also impact the UEs in RRC_CONNECTED within the same cell which supports on-demand SIB1 for RRC_IDLE and/or RRC_INACTIVE UEs.

For one example, the UL WUS can be a PRACH.

For another example, the DL indication can be a RAR in response to a PRACH.

For yet another example, the configuration can be provided by a system information block (e.g., SIBx, where x≥1).

This disclosure focuses on configuration and transmission of on-demand SIB1 transmission. More precisely, the following aspects are included in the disclosure:
Determination of time instance A for starting to monitor Type0-PDCCH
   Without explicit indication of a time offset
   With explicit indication of a time offset
Determination of time instance B for stopping to monitor Type0-PDCCH
   With another DL indication
   With explicit indication of a time duration from time instance A
   Without indication
Configuration for UL WUS, DL indication, and on-demand SIB1
   Configuration by higher layer parameters
   Configuration by DL indication
Example UE procedure

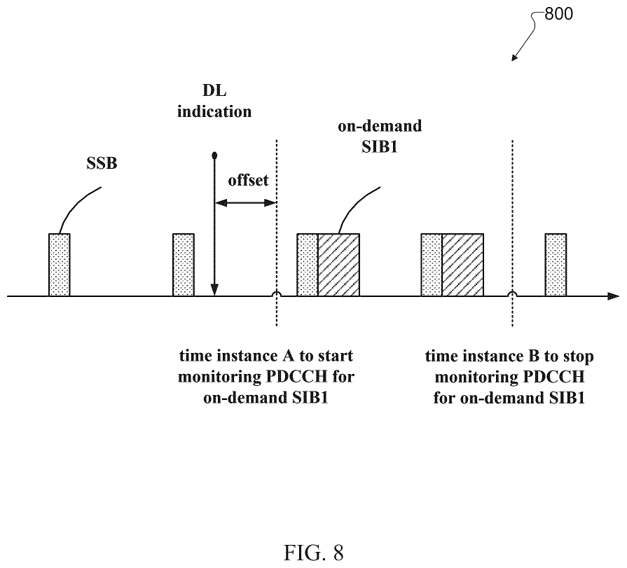

FIG. 8 illustrates an example PDCCH monitoring time instance 800 according to embodiments of the present disclosure. For example, PDCCH monitoring time instance 800 can be determined by any of the UEs 111-116 of FIG. 1, such as the UE 113. This example is for illustration only and other embodiments can be used without departing from the scope of the present disclosure.

For one example, the UE can determine a time instance A (e.g., with a time domain offset) such that the UE can assume on-demand SIB1 transmissions occur after time instance A (e.g., such that the UE can begin to monitor Type0-PDCCH).

For another example, the UE can determine a time instance B such that on-demand SIB1 transmissions terminate at time instance B and no on-demand SIB1 transmissions occur after time instance B. For one further instance, for some example procedures, the time instance B is absent, which means the on-demand SIB1 transmission can occur without a termination time instance (e.g., no ending time for the monitoring window).

For yet another example, the UE monitors some or all of the Type0-PDCCH based on the monitoring occasions between time instance A and time instance B (e.g., a monitoring window). For one further instance, the UE is not required to monitor Type0-PDCCH based on the monitoring occasions outside the monitoring window(s).

An illustration of time instance A and/or time instance B is shown in FIG. 8.

In one embodiment, a UE can determine the time instance A based on the DL indication, wherein the time instance A is determined as the starting instance of the slot that satisfying at least one of the following conditions (including combination of conditions).

For one condition, the slot can be a first slot that satisfying the at least one conditions.

For one condition, the slot can be from or after the reception of the DL indication.

For one condition, the slot is a first slot in a half frame.

For another condition, the slot is a first slot in a frame.

For yet another condition, the slot is a first slot in a period, wherein the period corresponds to the periodicity of the Type0-PDCCH monitoring occasions, or corresponds to system information update period.

For one condition, the slot is a first slot in a half frame that includes Type0-PDCCH monitoring occasions.

For another condition, the slot is a first slot in a frame that includes Type0-PDCCH monitoring occasions.

For yet another condition, the slot is a first slot in a period that includes Type0-PDCCH monitoring occasions, wherein the period corresponds to the periodicity of the Type0-PDCCH monitoring occasions.

For yet another condition, the slot is a first slot in a period that includes Type0-PDCCH monitoring occasions, wherein the period corresponds to the transmission time interval (TTI) of SIB1.

For one condition, the slot is a first slot including a Type0-PDCCH monitoring occasion.

For another condition, the slot is a first slot including a Type0-PDCCH monitoring occasion corresponding to SSB index 0.

For yet another condition the slot is a first slot including a Type0-PDCCH monitoring occasion corresponding to a first actually transmitted SSB index (e.g., first actually transmitted SSB index determined based on higher layer parameter such as ssb-PositionsInBurst).

For yet another condition the slot is a first slot including a Type0-PDCCH monitoring occasion corresponding to a first candidate SSB which further corresponds to the first actually transmitted SSB index (e.g., first actually transmitted SSB index determined based on higher layer parameter such as ssb-PositionsInBurst).

For one condition, the slot is at least with a time domain delay of T after the DL indication. For instance, the delay of T can at least include a processing delay for the DL indication.

For one condition, the slot is outside the RAR window for receiving the DL indication (e.g., after the last slot for the RAR window).

For another condition, the slot is the starting slot of the RAR window for receiving the DL indication. For one further evaluation, the slot for time instance A is after the reception of the DL indication with a time domain delay of T.

For one example, when combination of conditions herein happens, the slot refers to the later or the latest slot among the slots according to multiple of the conditions.
For one sub-example, the slot is the first slot after the reception of the DL indication (e.g., RAR in response to a UL WUS) or the first slot after a configured time offset with respect to the starting slot of the RAR window for receiving the DL indication (e.g., RAR in response to a UL WUS), whichever occurs later in time domain.
For another sub-example, the slot is the first slot after the reception of the DL indication (e.g., RAR in response to a UL WUS) with a time domain delay (e.g., T as in the example of this disclosure) or the first slot after a configured time offset with respect to the starting slot of the RAR window for receiving the DL indication (e.g., RAR in response to a UL WUS), whichever occurs later in time domain.

For one embodiment, the time instance A is determined as the starting instance of the slot that is O slots after a slot (or an ending slot within a number of slots) wherein the DL indication is received or wherein the RAR window for receiving the DL indication starts or terminates. At least one example, or at least one combination of examples can be supported.

For one example, O can be indicated by the DL indication. For instance, a set of candidate values for O can be provided by higher layer parameter (such as system information block) and/or predefined in the specification of the system operation, and the DL indication indicates one from the candidate values.

For another example, O can be provided by the configuration (e.g., configuration of UL WUS as in FIG. 5, which can be higher layer parameter such as system information block).

For yet another example, O can be fixed or pre-determined.

For one example, the UE can expect the time instance A is aligned with the starting instance of a first slot in a half frame.

For another example, the UE can expect the time instance A is aligned with the starting instance of a first slot in a frame.

For yet another example, the UE can expect the time instance A is aligned with the starting instance of a first slot in a period, wherein the period corresponds to the periodicity of the Type0-PDCCH monitoring occasions, or corresponds to a period for system information update.

For one example, the UE can expect the time instance A is aligned with the starting instance of a slot in a half frame that includes Type0-PDCCH monitoring occasions.

For another example, the UE can expect the time instance A is aligned with the starting instance of a slot in a frame that includes Type0-PDCCH monitoring occasions.

For yet another example, the UE can expect the time instance A is aligned with the starting instance of a slot in a period that includes Type0-PDCCH monitoring occasions, wherein the period corresponds to the periodicity of the Type0-PDCCH monitoring occasions.

For yet another example, the UE can expect the time instance A is aligned with the starting instance of a slot in a period that includes Type0-PDCCH monitoring occasions, wherein the period corresponds to the TTI of SIB1.

For one example, the UE can expect the time instance A is aligned with the starting instance of a slot including a Type0-PDCCH monitoring occasion.

For another example, the UE can expect the time instance A is aligned with the starting instance of a slot including a Type0-PDCCH monitoring occasion corresponding to SSB index 0.

For yet another example, the UE can expect the time instance A is aligned with the starting instance of a slot including a Type0-PDCCH monitoring occasion corresponding to a first actually transmitted SSB index (e.g., first actually transmitted SSB index determined based on higher layer parameter such as ssb-PositionsInBurst).

For yet another example, the UE can expect the time instance A is aligned with the starting instance of a slot including a Type0-PDCCH monitoring occasion corresponding to a first candidate SSB which further corresponds to the first actually transmitted SSB index (e.g., first actually transmitted SSB index determined based on higher layer parameter such as ssb-PositionsInBurst).

For one example, the UE can expect O is no less than a delay of T. For instance, the delay of T can at least include a processing delay for the DL indication. For another instance, T can be pre-determined as 0.

For one example, the UE can expect the time instance A is outside the RAR window for receiving the DL indication.

For another example, the slot is the starting slot of the RAR window for receiving the DL indication, with a configured time offset O with respect to the starting slot of the RAR window. For one further evaluation, the configuration of time offset O could grantee that the slot for time instance A is after the reception of the DL indication with a time domain delay of T.

For one further consideration, when combination of examples in this closure happens, the slot for time instance A refers to the later or the latest slot among the slots according to multiple of the examples, wherein the examples can be according to either with explicit indication or without explicit indication.
For one instance, the slot is the first slot from or after the reception of the DL indication (e.g., RAR in response to a UL WUS), or the first slot after a configured time offset O with respect to the starting slot of the RAR window for receiving the DL indication (e.g., RAR in response to a UL WUS), whichever occurs later in time domain. Time instance A is determined as max(N_start+O, N_RAR), or max(N_start+O, N_RAR+1), wherein N_start is the starting slot index of the RAR window for receiving the DL indication (e.g., RAR in response to a UL WUS), O is the configured domain offset, and N_RAR is the slot or last slot within the slots where the DL indication (e.g., RAR in response to a UL WUS) is received.
For another instance, the slot is the first slot from or after the reception of the DL indication (e.g., RAR in response to a UL WUS) with a time domain delay (e.g., T as in the example of this disclosure), or the first slot after a configured time offset O with respect to the starting slot of the RAR window for receiving the DL indication (e.g., RAR in response to a UL WUS), whichever occurs later in time domain. Time instance A is determined as max(N_start+O, N_RAR+T), or max(N_start+O, N_RAR+T+1), wherein N_start is the starting slot index of the RAR window for receiving the DL indication (e.g., RAR in response to a UL WUS), O is the configured domain offset, N_RAR is the slot or last slot within the slots where the DL indication (e.g., RAR in response to a UL WUS) is received, and T is the time domain delay (e.g., for processing the RAR as in the example of this disclosure).

For another further consideration, when combination of examples in this closure happens, a window from time instance A to time instance B for monitoring PDCCH for on-demand SIB1 can be determined by at least one example in this disclosure, and a UE can be further required to monitor a subset of time duration within the window according to another at least one example in this disclosure, wherein the examples can be according to either with explicit indication or without explicit indication.
For one instance, the window for monitoring PDCCH of on-demand SIB1 starts from the slot after a configured time offset O with respect to the starting slot of the RAR window for receiving the DL indication (e.g., RAR in response to a UL WUS), and the UE starts monitoring PDCCH for on-demand SIB1 from the starting slot of the window or the first slot from or after the reception of the DL indication (e.g., RAR in response to a UL WUS), whichever occurs later in time domain. Time instance A is determined as N_start+O, wherein N_start is the starting slot index of the RAR window for receiving the DL indication (e.g., RAR in response to a UL WUS), O is the configured domain offset, and the UE starts to monitor PDCCH for on-demand SIB1 from slot max(N_start+O, N_RAR), or max(N_start+O, N_RAR+1), where N_RAR is the slot or last slot within the slots where the DL indication (e.g., RAR in response to a UL WUS) is received.
For another instance, the window for monitoring PDCCH of on-demand SIB1 starts from the slot after a configured time offset O with respect to the starting slot of the RAR window for receiving the DL indication (e.g., RAR in response to a UL WUS), and the UE starts monitoring PDCCH for on-demand SIB1 from the starting slot of the window or the first slot from or after the reception of the DL indication (e.g., RAR in response to a UL WUS) with a time domain delay (e.g., T as in the example of this disclosure), whichever occurs later in time domain. Time instance A is determined as N_start+O, wherein N_start is the starting slot index of the RAR window for receiving the DL indication (e.g., RAR in response to a UL WUS), O is the configured domain offset, and the UE starts to monitor PDCCH for on-demand SIB1 from slot max(N_start+O, N_RAR+T), or max(N_start+O, N_RAR+T+1), where N_RAR is the slot or last slot within the slots where the DL indication (e.g., RAR in response to a UL WUS) is received, and T is the time domain delay (e.g., for processing the RAR as in the example of this disclosure).

For yet another further instance, when using the example or instance of this embodiment to determine the slot for starting monitoring PDCCH of on-demand SIB1, if the slot is later than the time instance B (e.g., slot for terminating monitoring PDCCH of on-demand SIB1), then the UE is not required to monitor PDCCH of on-demand SIB1.

For one embodiment, a UE can determine the time instance B based on another DL indication separate from the DL indication to determine the time instance A. The UE can determine the time instance B as a starting (or ending) instance of a slot that satisfying at least one of the following conditions (including combination of conditions).

For one condition, the slot can be a first slot that satisfying the at least one conditions.

For one condition, the slot can be after the reception of another DL indication.

For one condition, the slot is a first (or a last) slot in a half frame.

For another condition, the slot is a first (or a last) slot in a frame.

For yet another condition, the slot is a first (or a last) slot in a period, wherein the period corresponds to the periodicity of the Type0-PDCCH monitoring occasions, or corresponds to the period for system information update.

For one condition, the slot is a first (or a last) slot in a half frame that includes Type0-PDCCH monitoring occasions.

For another condition, the slot is a first (or a last) slot in a frame that includes Type0-PDCCH monitoring occasions.

For yet another condition, the slot is a first (or a last) slot in a period that includes Type0-PDCCH monitoring occasions, wherein the period corresponds to the periodicity of the Type0-PDCCH monitoring occasions.

For yet another condition, the slot is a first (or a last) slot in a period that includes Type0-PDCCH monitoring occasions, wherein the period corresponds to the TTI of SIB1.

For one condition, the slot is a first (or a last) slot including a Type0-PDCCH monitoring occasion.

For another condition, the slot is a first (or a last) slot including a Type0-PDCCH monitoring occasion corresponding to SSB index 0.

For yet another condition the slot is a first (or a last) slot including a Type0-PDCCH monitoring occasion corresponding to a first actually transmitted SSB index (e.g., first actually transmitted SSB index determined based on higher layer parameter such as ssb-PositionsInBurst).

For yet another condition the slot is a first (or a last) slot including a Type0-PDCCH monitoring occasion corresponding to a first candidate SSB which further corresponds to the first actually transmitted SSB index (e.g., first actually transmitted SSB index determined based on higher layer parameter such as ssb-PositionsInBurst).

For another condition, the slot is a first (or a last) slot including a Type0-PDCCH monitoring occasion corresponding to a maximum SSB index.

For yet another condition the slot is a first (or a last) slot including a Type0-PDCCH monitoring occasion corresponding to a last actually transmitted SSB index (e.g., last actually transmitted SSB index determined based on higher layer parameter such as ssb-PositionsInBurst).

For yet another condition the slot is a first (or a last) slot including a Type0-PDCCH monitoring occasion corresponding to a last candidate SSB which further corresponds to the last actually transmitted SSB index (e.g., last actually transmitted SSB index determined based on higher layer parameter such as ssb-PositionsInBurst).

For one condition, the slot is at least with a delay of T after another DL indication. For instance, the delay of T can at least include a processing delay for another DL indication.

For one embodiment, a UE can determine a time instance B based on the time instance A and a duration between time instance A and time instance B, wherein the time instance B can be a starting (or ending) time instance of a slot. For instance, N_B=N_A+D, wherein N_A is the slot index for time instance A, and N_B is the slot index for time instance B, and D is the duration between time instance A and time instance B.

For one example, the duration can be fixed or pre-determined.

For another example, the duration can be configured by higher layer parameter (such as system information block).
For one instance, the candidate values for the duration can be with a form of an integer multiple of 20 ms (or equivalently number of slots), such as {20, 40, 80, 160} ms or its subset, or such as {20, 40, 60, 80, 100, 120, 140, 160} ms or its subset. For one instance, this can be applicable at least for the SS/PBCH block and CORESET #0 multiplexing pattern 1.
For another instance, the candidate values for the duration can be with a form of an integer multiple of 5 ms (or equivalently number of slots), such as {5, 10, 20, 40, 80, 160} ms or its subset; or such as {5, 10, 20, 40, 60, 80, 100, 120, 140, 160} ms or its subset; or such as {5, 10, 15, 20, 25, 30, 35, 40, 60, 80, 100, 120, 140, 160} ms or its subset; or such as {5, 10, 15, 20, 25, . . . , 160} ms or its subset.
For another instance, the candidate values for the duration can be with a form of an integer multiple of the periodicity of SS/PBCH block, such as {1, 2, 3, 4, 5, 6, 7, 8}. For one instance, this can be applicable at least for the SS/PBCH block and CORESET #0 multiplexing pattern 2 or 3.
For yet another instance, the candidate values for the duration can be with a form of an integer multiple of 5 ms (or equivalently number of slots) and further depends on the frequency range, such as:
   For FR1, {20, 40, 80, 160} ms or its subset;
   For FR2, {5, 10, 20, 40, 80, 160} ms or its subset.
For yet another instance, the candidate values for the duration can be in a unit of slot, such as {5, 10, 20, 40, 80, 160, 320, 640, 1280, 2560, 5210, 10240, 20480, 40960, 81920} slots or its subset; or such as {5, 10, 15, . . . , 81920} slots or its subset.
For yet another instance, the candidate values for the duration can be in a unit of slot, such as {20, 40, 80, 160, 320, 640, 1280, 2560, 5210, 10240, 20480, 40960, 81920} slots or its subset; or such as {20, 25, 30, . . . , 81920} slots or its subset.
For yet another instance, the candidate values for the duration can be in a unit of slot, such as {20, 40, 80, 160, 320, 640, 1280, 2560, 5210, 10240} slots or its subset; or such as {20, 25, 30, . . . , 10240} slots or its subset.
For yet another instance, the candidate values for the duration can be in a unit of slot, and further depends on the frequency range, such as:
   For FR1, {20, 40, 80, 160, 320} slots or its subset;
   For FR2-1, {20, 40, 80, 160, 320, 640, 1280, 2560, 5210, 10240} slots or its subset;
   For FR2-2, {40, 80, 160, 320, 640, 1280, 2560, 5210, 10240, 20480, 40960, 81920} slots or its subset.
For yet another instance, the candidate values for the duration can be in a unit of slot, and further depends on the frequency range, such as:
   For FR1, {20, 40, 80, 160, 320} slots or its subset;
   For FR2-1, {20, 40, 80, 160, 320, 640, 1280} slots or its subset;
   For FR2-2, {40, 80, 160, 320, 640, 1280, 2560, 5210, 10240} slots or its subset.
For one further evaluation, a special value can be added to instances herein to indicate the window for monitoring PDCCH for on-demand SIB1 is without an ending instance, e.g., the UE can assume SIB1 is periodically transmitted after time instance A.
For another further evaluation, when the higher layer parameter is not configured, the UE can assume a default value as the duration of the window, e.g., the default value can be 0 (e.g., the UE is not required to monitor); or the default value can be minimum in the candidate values; or the default value can be maximum in the candidate values; or the default value can be 20 ms; or the default value can be 160 ms.
For yet another further instance, when the higher layer parameter is not configured, the UE can assume the window for monitoring PDCCH for on-demand SIB1 is without an ending instance, e.g., the UE can assume SIB1 is periodically transmitted after time instance A.

For yet another example, the duration can be provided by the DL indication (e.g., the one used to determine time instance A).

For yet another example, if the duration is not known to the UE, e.g., not provided by higher layer parameter or not provided by the DL indication, the UE can assume not to monitor PDCCH for on-demand SIB1.

For yet another example, if the duration is not known to the UE, e.g., not provided by higher layer parameter or not provided by the DL indication, the UE can monitor PDCCH for on-demand SIB1 without an ending instance of the monitoring window, e.g., the UE can assume SIB1 is periodically transmitted after time instance A.

For one example, the UE (e.g., the UE 116) can expect the time instance B is aligned with the starting (or ending) instance of a first (or a last) slot in a half frame.

For another example, the UE can expect the time instance B is aligned with the starting (or ending) instance of a first (or a last) slot in a frame.

For yet another example, the UE can expect the time instance B is aligned with the starting (or ending) instance of a first (or a last) slot in a period, wherein the period corresponds to the periodicity of the Type0-PDCCH monitoring occasions, or corresponds to the period for system information update.

For one example, the UE can expect the time instance B is aligned with the starting (or ending) instance of a slot in a half frame that includes Type0-PDCCH monitoring occasions.

For another example, the UE can expect the time instance B is aligned with the starting (or ending) instance of a slot in a frame that includes Type0-PDCCH monitoring occasions.

For yet another example, the UE can expect the time instance B is aligned with the starting (or ending) instance of a slot in a period that includes Type0-PDCCH monitoring occasions, wherein the period corresponds to the periodicity of the Type0-PDCCH monitoring occasions.

For yet another example, the UE can expect the time instance B is aligned with the starting (or ending) instance of a slot in a period that includes Type0-PDCCH monitoring occasions, wherein the period corresponds to the TTI of SIB1.

For one example, the UE can expect the time instance B is aligned with the starting (or ending) instance of a slot including a Type0-PDCCH monitoring occasion.

For another example, the UE can expect the time instance B is aligned with the starting (or ending) instance of a slot including a Type0-PDCCH monitoring occasion corresponding to SSB index 0.

For yet another example, the UE can expect the time instance B is aligned with the starting (or ending) instance of a slot including a Type0-PDCCH monitoring occasion corresponding to a first actually transmitted SSB index (e.g., first actually transmitted SSB index determined based on higher layer parameter such as ssb-PositionsInBurst).

For yet another example, the UE can expect the time instance B is aligned with the starting (or ending) instance of a slot including a Type0-PDCCH monitoring occasion corresponding to a first candidate SSB which further corresponds to the first actually transmitted SSB index (e.g., first actually transmitted SSB index determined based on higher layer parameter such as ssb-PositionsInBurst).

For another example, the UE can expect the time instance B is aligned with the starting (or ending) instance of a slot including a Type0-PDCCH monitoring occasion corresponding to a maximum SSB index.

For yet another example, the UE can expect the time instance B is aligned with the starting (or ending) instance of a slot including a Type0-PDCCH monitoring occasion corresponding to a last actually transmitted SSB index (e.g., last actually transmitted SSB index determined based on higher layer parameter such as ssb-PositionsInBurst).

For yet another example, the UE can expect the time instance B is aligned with the starting (or ending) instance of a slot including a Type0-PDCCH monitoring occasion corresponding to a last candidate SSB which further corresponds to the last actually transmitted SSB index (e.g., last actually transmitted SSB index determined based on higher layer parameter such as ssb-PositionsInBurst).

For one example, the UE can expect O is no less than a delay of T. For instance, the delay of T can at least include a processing delay for the DL indication. For another instance, the delay of T can be 0.

For one embodiment, a UE can determine a time instance B based on the time instance A, wherein time instance B is after time instance A.

For one example, the duration between time instance A and time instance B can be pre-defined in the specification for the system operation. For one instance, the duration can be pre-defined as a TTI time of the SIB1. For another instance, the duration can be pre-defined as a SSB periodicity. For yet another instance, the duration can be pre-defined as 20 ms.

For another example, the duration between time instance A and time instance B can be determined by a UE by its implementation.

For one further instance, this embodiment can be applicable when the explicit indication of the duration is not provided, and/or when the another explicit indication to terminate the on-demand SIB1 transmission is not received.

In one embodiment, a set of parameters related to at least one of the UL WUS, DL indication, or on-demand SIB1 can be provided by higher layer parameters (e.g., SIBx, where x>1), from a base station (e.g., a base station transmitting the on-demand SIB1 or another base station not transmitting the on-demand SIB1).

For one example, the set of parameters can include information related to the SS/PBCH block associated with the cell.
For one instance, at least one physical cell ID of the SS/PBCH block associated with the cell (e.g., PhysCellId).
For another instance, the frequency location of the SS/PBCH block associated with the cell (e.g., absoluteFrequencySSB, or a GSCN).
For yet another instance, the periodicity of the SS/PBCH block associated with the cell (e.g., ssb-PeriodicityServingCell).
For yet another instance, the actually transmitted SS/PBCH block indication for the SS/PBCH block associated with the cell (e.g., ssb-PositionsInBurst).
For yet another instance, the power of the SS/PBCH block associated with the cell (e.g., ss-PBCH-BlockPower).

For another example, the set of parameters can include information related to the DL information of the cell (e.g., downlinkConfigCommon).
For one instance, frequency domain information of the DL carrier (e.g., FrequencyInfoDL). For one further instance, the frequency domain information may further include at least one of absoluteFrequencySSB, frequencyBandList, absoluteFrequencyPointA, or scs-SpecificCarrierList. For another further instance, the scs-SpecificCarrierList can be simplified into a single configuration instead of a list (e.g., scs-SpecificCarrier), wherein the single configuration corresponds to the SCS of used for DL indication and/or on-demand SIB1 transmission (e.g., some field such as subcarrierSpacing could be absent). For yet another further instance, the scs-SpecificCarrierList or scs-SpecificCarrier can further include at least one of offsetToCarrier, subcarrierSpacing, carrierBandwidth or txDirectCurrentLocation
For another instance, a configuration for the (initial) downlink BWP to receive in the cell (e.g., initialDownlinkBWP or BWP-DownlinkCommon). For one further instance, the configuration for the (initial) downlink BWP can further include genericParameters (e.g., locationAndBandwidth, subcarrierSpacing, or cyclicPrefix), pdcch-ConfigCommon, or pdsch-ConfigCommon.
For yet another instance, a subcarrier spacing for signals and channels in the cell (e.g., SubcarrierSpacing).

For yet another example, the set of parameters can include information related to the PDCCH configurations (e.g., pdcch-ConfigCommon). For one further instance, the PDCCH configuration can be applicable at least for one of the DL indication or the on-demand SIB1.
For one instance, a search space configuration for monitoring PDCCH (e.g., searchSpaceZero and/or commonSearchSpaceList if search space other than searchSpaceZero is used for PDCCH of RAR). For one further instance, PDCCH of on-demand SIB1 uses searchSpaceZero. For another further instance, there can be one configuration included in commonSearchSpaceList (e.g., in this sense, commonSearchSpaceList can be simplified to commonSearchSpace), and it is applicable for PDCCH of RAR if configured.
For another instance, a CORESET configuration for monitoring PDCCH (e.g., controlResourceSetZero and/or commonControlResourceSet if CORESET other than CORESET #0 is used for PDCCH of RAR). For one further instance, PDCCH of on-demand SIB1 uses controlResourceSetZero. For another further instance, commonControlResourceSet is applicable for PDCCH of RAR if configured.

For yet another example, the set of parameters can include information related to the PDSCH configurations (e.g., pdsch-ConfigCommon).
For one instance, a list of time domain configurations for PDSCH resource allocation (e.g., pdsch-TimeDomainAllocationList). For one further instance, this is applicable for PDCCH of RAR.
For one instance, the information related to the PDSCH configurations is not included in the set of parameters, and the UE assumes to use a default time domain resource allocation table for the PDSCH of the DL indication (e.g., RAR) and/or the PDSCH for the on-demand SIB1.

For yet another example, the set of parameters can include information related to the UL information of the cell (e.g., uplinkConfigCommon).
For one instance, frequency domain information of the UL carrier (e.g., FrequencyInfoUL). For one further instance, the frequency domain information may further include at least one of frequencyBandList, absoluteFrequencyPointA, scs-SpecificCarrierList, p-Max, or frequencyShift7p5 khz. For another further instance, the scs-SpecificCarrierList can be simplified into a single configuration instead of a list (e.g., scs-SpecificCarrier), wherein the single configuration corresponds to the SCS of used for UL carrier for UL WUS transmission (e.g., some field such as subcarrierSpacing could be absent). For yet another further instance, the scs-SpecificCarrierList can further include at least one of offsetToCarrier, subcarrierSpacing, carrierBandwidth or txDirectCurrentLocation.
For another instance, a configuration related to the (initial) uplink BWP to receive in the cell (e.g., initialUplinkBWP or BWP-UplinkCommon, and/or its component field(s)). For one further instance, the configuration for the (initial) uplink BWP can further include genericParameters (e.g., at least one of locationAndBandwidth, subcarrierSpacing, or cyclicPrefix), and/or rach-ConfigCommon. For one further evaluation, for UL WUS, the UE can assume only one (initial) uplink BWP to include the ROs for UL WUS, and the subcarrier spacing is for the one (initial) uplink BWP and the associated carrier. For another further evaluation, this instance is applicable at least for frequency division duplexing (FDD) case. For yet another instance, if the configuration related to the (initial) uplink BWP (e.g., initialUplinkBWP or genericParameters or locationAndBandwidth) is not included in the set of parameters, the UE can assume the starting resource block (RB) of the (initial) uplink BWP has a fixed frequency domain offset comparing to the starting RB of the UL carrier, e.g., the fixed frequency domain offset can be 0 RB. For one further evaluation, the UE can further assume the bandwidth of the (initial) uplink BWP is same as the bandwidth of the carrier. For another further evaluation, the UE can further assume the configured ROs for UL WUS are within bandwidth of the (initial) uplink BWP.
For yet another instance, if the configuration related to the (initial) uplink BWP (e.g., initialUplinkBWP or genericParameters or locationAndBandwidth) is not included in the set of parameters, the UE can determine the offset (e.g., Msg1-FrequencyStart) for determining a first RO in the frequency domain (e.g., RO with lowest frequency) is with respect to the starting RB of the UL carrier. For one further evaluation, a value range for the offset (e.g., Msg1-FrequencyStart) can be extended.
For yet another instance, if the configuration related to the (initial) uplink BWP (e.g., initialUplinkBWP or genericParameters or cyclicPrefix) is not included in the set of parameters, the UE can determine extended CP is not applicable for UL WUS.

For yet another example, the set of parameters can include information related to the UL WUS configurations (e.g., rach-ConfigCommon).
For one instance, the generic configurations for RACH (e.g., RACH-ConfigGeneric). For one further instance, the generic configurations can include at least one of prach-ConfigurationIndex, msg1-FDM, msg1-FrequencyStart, zeroCorrelationZoneConfig, preambleReceivedTargetPower, preambleTransMax, powerRampingStep, ra-Response Window.
For another instance, the total number of random access preambles (e.g., totalNumberOfRA-Preambles).
For yet another instance, the number of SSB per RO (e.g., ssb-perRACH-OccasionAndCB-PreamblesPerSSB).
For yet another instance, random access contention resolution timer (e.g., ra-ContentionResolutionTimer).
For yet another instance, SSB reference signal received power (RSRP) threshold (e.g., rsrp-ThresholdSSB).
For yet another instance, PRACH root sequence index (e.g., prach-RootSequenceIndex).
For yet another instance, subcarrier spacing for PRACH (e.g., msg1-SubcarrierSpacing).
For yet another instance, PRACH restricted set configuration (e.g., restrictedSetConfig).

For yet another example, the set of parameters can include information related to the PRACH preamble resources allocated for UL WUS (e.g., FeatureCombinationPreambles).
For one instance, the parameters can include at least one of featureCombination, startPreambleForThisPartition, numberOfPreamblesPerSSB-ForThisPartition, ssb-SharedRO-MaskIndex, groupBconfigured, rsrp-ThresholdSSB, deltaPreamble, msg1-RepetitionNum, or msg1-RepetitionTimeOffsetROGroup.

For yet another example, the set of parameters can include information related to the UL WUS configuration (e.g., SI-RequestConfig).
For one instance, a RACH occasion configuration (e.g., rach-OccasionsSI). For one further instance, it may further include rach-ConfigSI and ssb-perRACH-Occasion. For another further instance, rach-ConfigSI can be from generic configurations for RACH (e.g., RACH-ConfigGeneric). For one further instance, the generic configurations can include at least one of prach-ConfigurationIndex, msg1-FDM, msg1-FrequencyStart, zeroCorrelationZoneConfig, preambleReceivedTargetPower, preambleTransMax, powerRampingStep, ra-ResponseWindow.
For another instance, a request period for UL WUS (e.g., si-RequestPeriod).
For yet another instance, resources for the UL WUS (e.g., si-RequestResources). For one further instance, it may further include ra-PreambleStartIndex, ra-AssociationPeriodIndex, and ra-ssb-OccasionMaskIndex.

For yet another example, the set of parameters can include information related to repeated transmission of the UL WUS (e.g., SI-RequestConfigRepetition).
For one instance, a RACH occasion configuration (e.g., rach-OccasionsSI). For one further instance, it may further include rach-ConfigSI and ssb-perRACH-Occasion.
For another instance, a number of repetitions, e.g., from si-RequestResourcesRepetitionNum2, si-RequestResourcesRepetitionNum4, or si-RequestResourcesRepetitionNum8. For one further instance, each field can be simplified to a single configuration for SIB1 request instead of a list. For another further instance, each field can be associated with a PRACH preamble starting index (e.g., ra-PreambleStartIndex).

For yet another example, the set of parameters can include information related to the SUL configurations (e.g., supplementaryUplink, and/or rsrp-ThresholdSSB-SUL).

For yet another example, the set of parameters can include information related to the PBCH payload.
For one instance, a common subcarrier spacing (e.g., subCarrierSpacingCommon).
For another instance, a subcarrier offset between SSB and common resource grid (e.g., ssb-SubcarrierOffset).
For yet another instance, a value of k_{SSB}.
For yet another instance, a value of ā_{Ā+5}.
For yet another instance, an indication on cell barring information (e.g., cellBarred).
For yet another instance, an indication of configuration for PDCCH associated with the SIB1 (e.g., PDCCH-ConfigSIB1), which may further include controlResourceSetZero and searchSpaceZero.

For yet another example, the set of parameters can include parameters related to on-demand SIB1 monitoring.
For one instance, an offset comparing to the DL indication to start monitoring PDCCH for on-demand SIB1.
For another instance, a duration for monitoring PDCCH for on-demand SIB1 (e.g., duration between time instance A and time instance B). For one further instances, the duration can be a number of periods or bursts for monitoring PDCCH for on-demand SIB1.
For yet another instance, a periodicity for bursts of PDCCH monitoring occasions.

For yet another example, the set of parameters can include information related to cell such as cell barring information (e.g., cellAccessRelatedInfo or BarringInfo).

For yet another example, the set of parameters can include a configuration for slot format in time division duplexing (TDD) configuration (e.g., tdd-UL-DL-ConfigurationCommon).

For yet another example, the set of parameters can include a configuration for timing advance offset (e.g., n-TimingAdvanceOffset).

For yet another example, the set of parameters can include configurations related to channel access for spectrum with shared channel access (e.g., at least one of channel AccessMode-r16, discoveryBurstWindowLength, useInterlacePUCCH-PUSCH, prach-RootSequenceIndex-r16, ra-ResponseWindow-v1610, channelAccessMode2-r17, or ra-ChannelAccess-r17).

For yet another example, the set of parameters can include configurations related to BWP configuration for devices with reduced capability (RedCap), e.g., initialDownlinkBWP-RedCap-r17, and/or initialUplinkBWP-RedCap-r17.

In one embodiment, a set of parameters at least related to on-demand SIB1 can be provided by the DL indication, from a base station (e.g., a base station transmitting the on-demand SIB1 or another base station not transmitting the on-demand SIB1).

For one example, the set of parameters can include an offset comparing to the DL indication to start monitoring PDCCH for on-demand SIB1.

For another example, the set of parameters can include a duration for monitoring PDCCH for on-demand SIB1 (e.g., duration between time instance A and time instance B). For one further instances, the duration can be a number of periods or bursts for monitoring PDCCH for on-demand SIB1.

For yet another example, the set of parameters can include a periodicity for bursts of PDCCH monitoring occasions.

For yet another example, the set of parameters can include an indication of configuration for PDCCH associated with the SIB1 (e.g., PDCCH-ConfigSIB1), which may further include controlResourceSetZero and searchSpaceZero.

For yet another example, the set of parameters can include an indication of a subcarrier spacing for the CORESET, e.g., for PDCCH associated with the SIB1.

For yet another example, the set of parameters can include a search space configuration, e.g., for monitoring PDCCH of on-demand SIB1 (e.g., searchSpaceZero and/or searchSpaceSIB1).

For yet another example, the set of parameters can include a CORESET configuration, e.g., for monitoring PDCCH of on-demand SIB1 (e.g., controlResourceSetZero and/or commonControlResourceSet).

For yet another example, the set of parameters can include a list of time domain configurations for PDSCH resource allocation (e.g., pdsch-TimeDomainAllocationList).

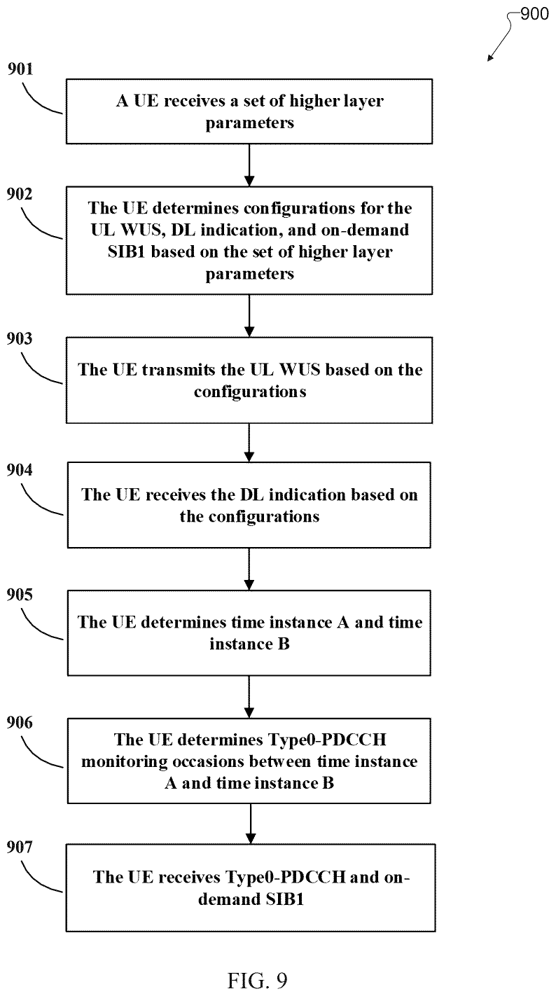

FIG. 9 illustrates a flowchart of an example UE procedure 900 for receiving Type0-PDCCH and on-demand SIB1 according to embodiments of the present disclosure. For example, procedure 900 can be performed by any of the UEs 111-116 if FIG. 1, such as the UE 114. This example is for illustration only and other embodiments can be used without departing from the scope of the present disclosure.

The procedure begins in 901, a UE receives a set of higher layer parameters. In 902, the UE determines configurations for the UL WUS, DL indication, and on-demand SIB1 based on the set of higher layer parameters. In 903, the UE transmits the UL WUS based on the configurations. In 904, the UE receives the DL indication based on the configurations. In 905, the UE determines time instance A and time instance B. In 906, the UE determines Type0-PDCCH monitoring occasions between time instance A and time instance B. In 907, the UE receives Type0-PDCCH and on-demand SIB1.

In one embodiment, an example UE procedure for receiving on-demand SIB1 is shown in FIG. 9.

In NR, for a SCell implemented with periodic SS/PBCH block transmission, a UE can be provided with a configuration for radio resource management (RRM) measurement based on the periodic SS/PBCH block, wherein the configuration can be provided by a RRC parameter. After the RRM measurement, the gNB can provide a configuration of the SCell, e.g., by another RRC parameter. The UE can be further provided with a MAC CE indicating an activation of the SCell, and by using the periodic SS/PBCH blocks on the SCell, or tracking reference signal (TRS) if configured, or the SS/PBCH blocks on the PCell when the SCell is without periodic SS/PBCH block transmission, the UE can get synchronized with the SCell and get ready to transmit or receive on the SCell. After activation of the SCell, if the SCell gets loss of synchronization, the UE can use the periodic SS/PBCH block for resynchronization. Since SS/PBCH block is transmitted on the SCell periodically, the power consumption for SS/PBCH block can be significantly large. Embodiments of the represent disclosure further recognize that on-demand SSB can be supported on the SCell to reduce power consumption.

In NR, for a SCell implemented with periodic SS/PBCH block transmission (or also called always-on SS/PBCH block, which is short for AO-SSB), a UE can be provided with a configuration for RRM measurement based on the periodic SS/PBCH block, wherein the configuration can be provided by a RRC parameter. After the RRM measurement, the gNB can provide a configuration of the SCell, e.g., by another RRC parameter. The UE can be further provided with a MAC CE indicating an activation of the SCell, and by using the periodic SS/PBCH blocks on the SCell, or TRS if configured, or the SS/PBCH blocks on the PCell when the SCell is without periodic SS/PBCH block transmission, the UE can get synchronized with the SCell and get ready to transmit or receive on the SCell. After activation of the SCell, if the SCell gets loss of synchronization, the UE can use the periodic SS/PBCH block for resynchronization. Since SS/PBCH block is transmitted on the SCell periodically, the power consumption for SS/PBCH block can be significantly large. To reduce the power consumption, on-demand SSB can be supported on the SCell.

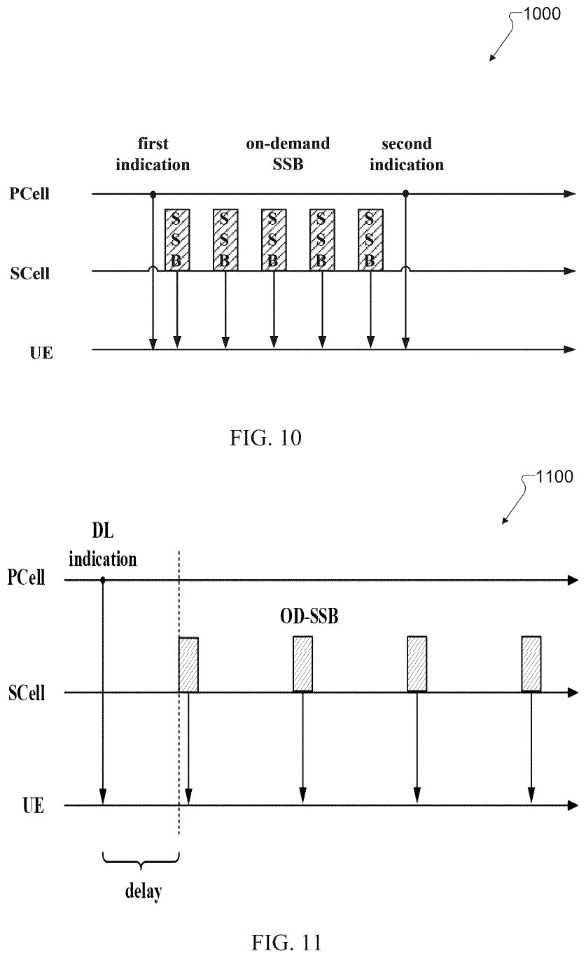

FIG. 10 illustrates an example indication/trigger for on-demand SSB transmissions 1000 according to embodiments of the present disclosure. For example, indication/trigger for on-demand SSB transmissions 1000 can be triggered by the BS 102 of FIG. 2. This example is for illustration only and other embodiments can be used without departing from the scope of the present disclosure.

For example, on-demand SSB(s) can be triggered to be transmitted by a first indication (e.g., a first downlink control information (DCI) format, a first MAC CE, or a first higher layer parameter) from the gNB and/or triggered to be terminated by a second indication (e.g., a second DCI format, a first MAC CE, or a first higher layer parameter) from the gNB. For some example procedures, the second indication can be absent and the UE assumes the triggered on-demand SSB transmission is not terminated, e.g., periodic manner after triggered. An illustration of the on-demand SSB triggered by gNB is shown in FIG. 10.

This disclosure includes the design details on measurement (e.g., L1 measurement) based on the on-demand SS/PBCH block (SSB).

This disclosure focuses on L1 measurement based on on-demand SSB. More precisely, the following aspects are included in the disclosure:
Configuration of L1 measurement based on on-demand SSB
Triggering mechanism of L1 measurement based on on-demand SSB
Performing L1 measurement based on on-demand SSB
Terminating L1 measurement based on on-demand SSB
Reporting L1 measurement based on on-demand SSB
Configuring on-demand SSB as quasi co-location (QCL) source
Example UE procedure

In one embodiment, on-demand SSB can be configured to be used for LI measurement (e.g., channel state information (CSI) measurement).

For one example, the UE can be configured with information related to the on-demand SSB in the higher layer parameter for a serving cell (e.g., servingCellConfig or servingCellConfigCommon). For one instance, parameters related to the on-demand SSB can be added to the configuration for the serving cell (e.g., servingCellConfig or servingCellConfigCommon), wherein for example, the parameters related to the on-demand SSB can include at least one of periodicity(ies) of the on-demand SSB (e.g., ssb-PeriodicityServingCell, or ssb-PeriodicityServingCellList, or ssb-FirstPeriodicityServingCell and ssb-SecondPeriodicityServingCell), transmission power of the on-demand SSB (e.g., ss-PBCH-BlockPower), physical cell ID of the on-demand SSB (e.g., physicalCellId), frequency location of the on-demand SSB (e.g., ssbAbsoluteFrequency or ssbFrequency), or actually transmitted SSB in a burst for the on-demand SSB (e.g., ssb-PositionsInBurst).

For another example, the configuration for L1 measurement (e.g., CSI-MeasConfig) or report (e.g., CSI-ReportConfig) can include an explicit indication that the SSB resource for L1 measurement is on-demand SSB (e.g., the UE can be configured which type of SSB to be used for the L1 measurement). For one instance, an explicit field can be added in the configuration for SSB resource (e.g., CSI-SSB-ResourceSet) indicating that the associated SSB is on-demand SSB (e.g., absence of this field can indicate that the associated SSB is periodic). For another instance, an explicit field indicating an index of the on-demand SSB can be added in the configuration for SSB resource (e.g., CSI-SSB-ResourceSet), e.g., when there are more than one on-demand SSB supported in a cell.

For yet another example, the configuration for L1 measurement (e.g., CSI-MeasConfig) or report (e.g., CSI-ReportConfig) can include an explicit indication that the SSB resource for L1 measurement is periodic and/or on-demand SSB (e.g., the UE can be configured which type(s) of SSB to be used for the L1 measurement). For one instance, an explicit field can be added in the configuration for SSB resource (e.g., CSI-SSB-ResourceSet) indicating that the associated SSB is periodic SSB or on-demand SSB. For another instance, an explicit field can be added in the configuration for SSB resource (e.g., CSI-SSB-ResourceSet) indicating that the associated SSB is periodic SSB or on-demand SSB or both periodic and on-demand SSB. For yet another instance, an explicit field can be added in the configuration for SSB resource (e.g., CSI-SSB-ResourceSet) indicating that the associated SSB is on-demand SSB or both periodic and on-demand SSB, e.g., wherein the absence of this field indicates that the associated SSB is periodic.

In one further instance of example(s) herein, the configured SSB is associated with both periodic and on-demand SSB, when the center frequency of the periodic SSB and the center frequency of the on-demand SSB can be the same.

In another further instance of example(s) herein, the configured SSB is associated with both periodic and on-demand SSB, when the higher layer parameter timeRestrictionForChannelMeasurements in CSI-ReportConfig is set to “notConfigured”.

In yet another further instance of example(s) herein, the configured SSB is associated with on-demand SSB, when the center frequency of the periodic SSB and the center frequency of the on-demand SSB can be the different.

For yet another example, when the on-demand SSB is configured with an explicit field of physical cell ID (e.g., physicalCellId), the configuration for L1 measurement (e.g., CSI-MeasConfig) or report (e.g., CSI-ReportConfig) can include the physical cell ID such that the UE can identify the associated SSB is on-demand SSB. For one instance, an explicit field can be added in the configuration for SSB resource (e.g., CSI-SSB-ResourceSet) indicating the physical cell ID of the on-demand SSB (e.g., physicalCellId).

For yet another example, when the on-demand SSB is configured with an explicit field of frequency location (e.g., ssbFrequency), the configuration for L1 measurement (e.g., CSI-MeasConfig) or report (e.g., CSI-ReportConfig) can include the frequency location such that the UE can identify the associated SSB is on-demand SSB. For one instance, an explicit field can be added in the configuration for SSB resource (e.g., CSI-SSB-ResourceSet) indicating the frequency location of the on-demand SSB (e.g., ssbFrequency).

For yet another example, on-demand SSB can use a different set of SSB index from periodic SSB in the same cell. A UE (e.g., the UE 116) can distinguish the SSB configured in the configuration for L1 measurement as on-demand SSB or not based on the SSB index.

FIG. 11 illustrates an example indication/trigger for L1 measurements 1100 according to embodiments of the present disclosure. For example, indication/trigger for L1 measurements 1100 can be triggered by the BS 102 of FIG. 2. This example is for illustration only and other embodiments can be used without departing from the scope of the present disclosure.

In one embodiment, a UE can receive a DL indication from the BS (e.g., the BS 102) indicating that the UE can start to perform L1 measurement.

An illustration of the embodiment is shown in FIG. 11.

For one example, the DL indication can be provided by higher layer (e.g., RRC parameters).
For one instance, the RRC parameters also include at least one of a configuration for the SCell (e.g., ServingCellConfig), a configuration for the on-demand SSB, an activation of the SCell (e.g., sCellState), or an activation of the on-demand SSB.
For another instance, a UE can determine that the L1 measurement based on on-demand SSB could be performed after a delay with respect to the reception of the higher layer parameters (e.g., the delay for processing the higher layer parameters).
For yet another instance, the UE may not be required to perform L1 measurement based on on-demand SSB before the delay with respect to the reception of the higher layer parameters.
For yet another instance, the delay can be fixed (e.g., 16 ms)
In another example, the delay may be subject to UE capability.

For another example, the DL indication can be provided by a MAC CE.
For one instance, the MAC CE for triggering L1 measurement can be same as a MAC CE for activating on-demand SSB transmission. For one sub-instance, the reception of the MAC CE for activating on-demand SSB transmission can imply the activation of L1 measurement based on the on-demand SSB. For another sub-instance, there can be an explicit field in the MAC CE for activating on-demand SSB transmission indicating whether to start performing L1 measurement.
For another instance, the MAC CE for triggering L1 measurement can be same as a MAC CE for activating the SCell. For one sub-instance, the reception of the MAC CE for activating the SCell can imply the activation of L1 measurement based on the on-demand SSB. For another sub-instance, there can be an explicit field in the MAC CE for activating the SCell indicating whether to start performing L1 measurement.
For yet another instance, the MAC CE for triggering L1 measurement can be a separate MAC CE from the MAC CE for activating on-demand SSB transmission and the MAC CE for activating the SCell.
For yet another instance, a UE can determine that the L1 measurement based on on-demand SSB could be performed after a delay with respect to the reception of the MAC CE (e.g., the delay for processing the MAC CE).
In one example, the delay can be fixed or subject to UE capability
For yet another instance, the UE may not be required to perform L1 measurement based on on-demand SSB before the delay with respect to the reception of the MAC CE.
For yet another instance, the UE may not expect to receive the MAC CE for triggering L1 measurement earlier than the MAC CE for activating the on-demand SSB transmission.
For yet another instance, the UE may not expect to receive the MAC CE for triggering L1 measurement later than the MAC CE for activating the SCell.

For yet another example, the DL indication can be provided by a DCI format.
For one instance, a UE can determine that the L1 measurement based on on-demand SSB could be performed after a delay with respect to the reception of the DCI format (e.g., the delay for processing the DCI format).
For yet another instance, the UE may not be required to perform L1 measurement based on on-demand SSB before the delay with respect to the reception of the DCI format.
For yet another instance, the delay can be fixed or pre-determined (e.g., 0 or 1 slot).
For yet another instance, the delay can be subject to a UE capability.
For yet another instance, the UE may not expect to receive the DCI format for triggering L1 measurement earlier than the MAC CE for activating the on-demand SSB transmission.
For yet another instance, the UE may not expect to receive the DCI format for triggering L1 measurement later than the MAC CE for activating the SCell.

In one embodiment, a UE can perform L1 measurement based on at least the on-demand SSB.

For one example, the UE can perform L1 measurement based on at least the on-demand SSB to determine at least one of a layer 1 reference signal received power (L1-RSRP) or a SS/PBCH block resource indicator (SSBRI).

For another example, the UE can perform L1 measurement based on on-demand SSB during the period where the UE determines the on-demand SSB is transmitted, e.g., after the time instance A that the UE determines the on-demand SSB starts to be transmitted, and before the time instance B that the UE determines the on-demand SSB terminates to be transmitted.
For one further evaluation, this example can be applicable when the configured SSB is associated with on-demand SSB only.

For yet another example, the UE may at least perform L1 measurement based on both periodic SSB and/or on-demand SSB, e.g., measuring N_{SSB} samples of the SSB within a period of T, wherein the SSB can be periodic SSB or on-demand SSB subject to the UE's selection, and the L1 measurement can be based on a combination of periodic SSB or on-demand SSB if they both occurs in the period of T.
For one further evaluation, this example can be applicable when the configured SSB is associated with both periodic SSB and on-demand SSB.
For another further evaluation, this example can be applicable when the center frequency of the periodic SSB and the center frequency of the on-demand SSB are the same.
For yet another further evaluation, this example can be applicable when the higher layer parameter timeRestrictionForChannelMeasurements in CSI-ReportConfig is set to “notConfigured”.

For yet another example, the UE may perform L1 measurement based on on-demand SSB separately from the L1 measurement based on periodic SSB, if both on-demand SSB and periodic SSB are configured in the same cell. When performing L1 measurement based on on-demand SSB, only samples corresponding to on-demand SSB could be used for determining the measurement result for L1 measurement based on on-demand SSB.

For yet another example, the UE may perform L1 measurement based on on-demand SSB only, e.g., measuring N_{SSB} samples of the SSB within a period of T, wherein the SSB can be on-demand SSB only.
For one further evaluation, this example can be applicable when the configured SSB is associated with on-demand SSB.
For another further evaluation, this example can be applicable when the center frequency of the periodic SSB and the center frequency of the on-demand SSB are the different.
For yet another further evaluation, this example can be applicable when the higher layer parameter timeRestrictionForChannelMeasurements in CSI-ReportConfig is set to “Configured”.

In one embodiment, a UE can receive another DL indication from the BS indicating that the UE can stop to perform L1 measurement.

For one example, another DL indication can be provided by higher layer (e.g., RRC parameters).
For one instance, the RRC parameters also include at least one of a deactivation of the SCell (e.g., sCellState), or a deactivation of the on-demand SSB.
For another instance, a UE can determine that the L1 measurement based on on-demand SSB could be stopped after a delay with respect to the reception of the higher layer parameters (e.g., the delay for processing the higher layer parameters).
For yet another instance, the UE may not be required to perform L1 measurement based on on-demand SSB after the delay with respect to the reception of the higher layer parameters.
For yet another instance, the delay can be fixed (e.g., 16 ms).

For another example, the DL indication can be provided by a MAC CE.
For one instance, the MAC CE for triggering L1 measurement can be same as a MAC CE for deactivating on-demand SSB transmission. For one sub-instance, the reception of the MAC CE for deactivating on-demand SSB transmission can imply the deactivation of L1 measurement based on the on-demand SSB. For another sub-instance, there can be an explicit field in the MAC CE for deactivating on-demand SSB transmission indicating whether to perform L1 measurement.
For another instance, the MAC CE for triggering L1 measurement can be same as a MAC CE for deactivating the SCell. For one sub-instance, the reception of the MAC CE for deactivating the SCell can imply the deactivation of L1 measurement based on the on-demand SSB. For another sub-instance, there can be an explicit field in the MAC CE for deactivating the SCell indicating whether to perform L1 measurement.
For yet another instance, the MAC CE for triggering L1 measurement can be a separate MAC CE from the MAC CE for deactivating on-demand SSB transmission and the MAC CE for deactivating the SCell.
For yet another instance, a UE can determine that the L1 measurement based on on-demand SSB could be stopped after a delay with respect to the reception of the MAC CE (e.g., the delay for processing the MAC CE).
For yet another instance, the UE may not be required to perform L1 measurement based on on-demand SSB after the delay with respect to the reception of the MAC CE.
For yet another instance, the UE may not expect to receive the MAC CE for deactivating L1 measurement later than the MAC CE for deactivating the on-demand SSB transmission.
For yet another instance, the UE may not expect to receive the MAC CE for deactivating L1 measurement earlier than the MAC CE for deactivating the SCell.
For yet another instance, the UE may not expect to receive the MAC CE for deactivating L1 measurement later than the MAC CE for deactivating the SCell.

For yet another example, the DL indication can be provided by a DCI format.
For one instance, a UE can determine that the L1 measurement based on on-demand SSB could be stopped after a delay with respect to the reception of the DCI format (e.g., the delay for processing the DCI format).
For yet another instance, the UE may not be required to perform L1 measurement based on on-demand SSB after the delay with respect to the reception of the DCI format.
For yet another instance, the delay can be fixed or pre-determined (e.g., 0 or 1 slot).
For yet another instance, the delay can be subject to a UE capability.
For yet another instance, the UE may not expect to receive the DCI format for deactivating L1 measurement later than the MAC CE for deactivating the on-demand SSB transmission.
For yet another instance, the UE may not expect to receive the DCI format for deactivating L1 measurement earlier than the MAC CE for deactivating the SCell.
For yet another instance, the UE may not expect to receive the DCI format for deactivating L1 measurement later than the MAC CE for deactivating the SCell.

In one embodiment, a UE can report the L1 measurement results to a base station, wherein the L1 measurement results are at least based on on-demand SSB.

For one example, a bit-width for reporting an index associated with a SSB beam can be determined based on the configurations for both periodic SSB and on-demand SSB. For one instance, when the UE determines the bit-width for periodic SSB as N₁ and the bit-width for on-demand SSB as N₂, then the UE can determine the bit-width in the measurement report as max {N₁, N₂}.
For one further evaluation, this example can be applicable when the configured SSB is associated with both periodic SSB and on-demand SSB, or when the L1 measurement is performed based on both periodic SSB and on-demand SSB.

For another example, the measurement report can include an indication on which type(s) of SSB is used for the L1 measurement. For one instance, an explicit field indicating at least one of periodic SSB and/or on-demand SSB can be added into the measurement report, e.g., for each of the reported SSB beam. For another instance, an explicit field indicating at least one of periodic SSB, on-demand SSB, or both periodic and on-demand SSB can be added into the measurement report, e.g., for each of the reported SSB beam. For yet another instance, an explicit field indicating at least one of on-demand SSB, or both periodic and on-demand SSB can be added into the measurement report, e.g., for each of the reported SSB beam.
For one further evaluation, this example can be applicable when the configured SSB is associated with both periodic SSB and on-demand SSB, or when the L1 measurement is performed based on both periodic SSB and on-demand SSB.
For another further evaluation, this example can be applicable when the higher layer parameter timeRestrictionForChannelMeasurements in CSI-ReportConfig is set to “Configured”.

For yet another example, the measurement report can include measurement results for periodic SSB and on-demand SSB separately. For one instance, this example can be applicable when the periodic SSB and on-demand SSB are using different SSB index(es).

In one embodiment, on-demand SSB cannot be used as a source RS for a QCL assumption.

For one further instance, the embodiment can be applicable when at least one of the following example holds.
Example 1: The actually transmitted SSB index(es) for on-demand SSB is same as or a subset of the actually transmitted SSB index(es) for periodic SSB, if both periodic and on-demand SSB are configured in the same cell.
Example 2: On-demand SSB is QCLed with periodic SSB when the SSB index is same (or when the SSB index is same after a module operation), if both periodic and on-demand SSB are configured in the same cell.
Example 3: The validation duration of the QCL assumption is same as or a subset of the transmission duration of the on-demand SSB, e.g., the QCL assumption is valid when the UE determines the on-demand SSB is transmitted.
Example 4: The transmission of on-demand SSB is in a periodic manner, e.g., after the on-demand SSB transmission is activated, the on-demand SSB transmission is with a periodicity.
Example 5: No periodic SSB transmission is configured in the same cell, e.g., only on-demand SSB is configured in the cell.
Example 6: A subset from QCL type A, B, C, or D could be applicable.

In one embodiment, on-demand SSB can be configured as the source reference signal in a transmission configuration indication (TCI) state (e.g., higher layer parameter TCI-State).

For one example, the TCI state (e.g., TCI-State) can include an explicit indication that which type of SSB to be used as the source RS. For one instance, an explicit field can be added in the configuration for QCL assumption (e.g., QCL-Info) indicating that the associated SSB is on-demand SSB (e.g., absence of this field can indicate that the associated SSB is periodic). For another instance, an explicit field indicating an index of the on-demand SSB can be added in the configuration for SSB resource (e.g., QCL-Info), e.g., when there are more than one on-demand SSB supported in a cell.

For another example, the TCI state (e.g., TCI-State) can include an explicit indication that the SSB as source RS is periodic and/or on-demand SSB (e.g., the UE can be configured which type of SSB to be used for the TCI state). For one instance, an explicit field can be added in the configuration for the TCI state (e.g., TCI-State) or QCL assumption (e.g., QCL-Info) indicating that the associated SSB is periodic SSB or on-demand SSB. For another instance, an explicit field can be added in the configuration for the TCI state (e.g., TCI-State) or QCL assumption (e.g., QCL-Info) indicating that the associated SSB is periodic SSB or on-demand SSB or both periodic and on-demand SSB. For yet another instance, an explicit field can be added in the configuration for the TCI state (e.g., TCI-State) or QCL assumption (e.g., QCL-Info) indicating that the associated SSB is on-demand SSB or both periodic and on-demand SSB, e.g., wherein the absence of this field indicates that the associated SSB is periodic.

In one further evaluation of example(s) herein, the SSB is associated with both periodic and on-demand SSB, when the center frequency of the periodic SSB and the center frequency of the on-demand SSB can be the same.

In another further evaluation of example(s) herein, the SSB is associated with on-demand SSB, when the center frequency of the periodic SSB and the center frequency of the on-demand SSB can be the different.

For yet another example, when the on-demand SSB is configured with an explicit field of physical cell ID (e.g., physicalCellId), the TCI state (e.g., TCI-State) can include the physical cell ID such that the UE can identify the associated SSB is on-demand SSB. For one instance, an explicit field can be added in the configuration for the TCI state (e.g., TCI-State) or QCL assumption (e.g., QCL-Info) indicating the physical cell ID of the on-demand SSB (e.g., physicalCellId).

For yet another example, when the on-demand SSB is configured with an explicit field of frequency location (e.g., ssbFrequency or ssbAbsoluteFrequency), the TCI state (e.g., TCI-State) can include the frequency location such that the UE can identify the associated SSB is on-demand SSB. For one instance, an explicit field can be added in the configuration for the TCI state (e.g., TCI-State) or QCL assumption (e.g., QCL-Info) indicating the frequency location of the on-demand SSB (e.g., ssbFrequency).

For yet another example, on-demand SSB can use a different set of SSB index from periodic SSB in the same cell. A UE can distinguish the SSB configured in the TCI state (e.g., TCI-State) as on-demand SSB or not based on the SSB index.

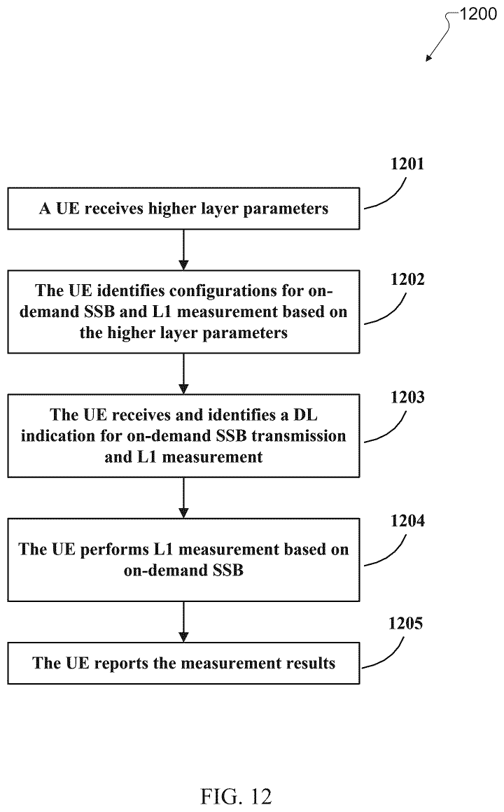

FIG. 12 illustrates a flowchart of an example UE procedure 1200 for L1 measurements according to embodiments of the present disclosure. For example, procedure 1200 can be performed by the UE 116 of FIG. 3. This example is for illustration only and other embodiments can be used without departing from the scope of the present disclosure.

The procedure begins in 1201, a UE receives higher layer parameters. In 1202, the UE identifies configurations for on-demand SSB and L1 measurement based on the higher layer parameters. In 1203, the UE receives and identifies a DL indication for on-demand SSB transmission and L1 measurement. In 1204, the UE performs L1 measurement based on on-demand SSB. In 1205, the UE reports the measurement results.

In one embodiment, an example UE procedure for L1 measurement based on on-demand SSB is shown in FIG. 12.

In one embodiment, the on-demand SSB is not associated with PRACH resources (e.g., on-demand SSB is not used in SSB to RO mapping).

For one example, a UE cannot perform handover (e.g., using higher layer parameter RRCReconfiguration to trigger handover) based on on-demand SSB in the target candidate cell(s) (but can still perform handover based on periodic SSB in the target candidate cell(s) if any).

For another example, a UE cannot perform L1/2 triggered mobility (LTM) based on on-demand SSB in the target candidate cell(s) (but can still perform LTM based on periodic SSB in the target candidate cell(s) if any).

In one embodiment, a UE can be configured to perform handover based on on-demand SSB in the target candidate cell(s). For one further instance, this embodiment can be applicable when at least one of the following examples holds.
Example 1: A periodic SSB is transmitted in the same cell as the on-demand SSB, and the actually transmitted SSB for on-demand SSB is same or a subset of the actually transmitted SSB for periodic SSB.
Example 2: No periodic SSB is transmitted in the same cell as the on-demand SSB.

For one example, the UE can be configured with information related to the on-demand SSB in the higher layer parameter for handover (e.g., RRCReconfiguration). For one instance, parameters related to the on-demand SSB can be added to the configuration for the target cell, e.g., a spCell using the configuration spCellConfigCommon in the reconfigurationWithSync in spCellConfig in CellGroupConfig in RRCReconfiguration, wherein for example, the parameters related to the on-demand SSB can include at least one of periodicity(ies) of the on-demand SSB (e.g., ssb-PeriodicityServingCell or ssb-Periodicity ServingCellList, or ssb-FirstPeriodicityServingCell and ssb-SecondPeriodicityServingCell), transmission power of the on-demand SSB (e.g., ss-PBCH-BlockPower), physical cell ID of the on-demand SSB (e.g., physicalCellId), frequency location of the on-demand SSB (e.g., ssbAbsoluteFrequency), or actually transmitted SSB in a burst for the on-demand SSB (e.g., ssb-PositionsInBurst).

In one embodiment, a UE can be indicated to perform L1/2 triggered mobility (LTM) based on on-demand SSB in the target candidate cell(s).

For one example, the LTM Cell Switch Command MAC CE can include an explicit indication that the SSB for LTM is on-demand SSB, e.g., using a reserved bit in the MAC CE.

For another example, higher layer parameters as candidate cell for LTM (e.g., ltm-Candidate) can include parameters related to the on-demand SSB. For one instance, parameters related to the on-demand SSB can be added to each applicable candidate cell configuration, e.g., Itm-Candidate or Itm-SSB-Config, wherein for example, the parameters related to the on-demand SSB can include at least one of periodicity(ies) of the on-demand SSB (e.g., ssb-PeriodicityServingCell or ssb-PeriodicityServingCellList, or ssb-FirstPeriodicityServingCell and ssb-SecondPeriodicityServingCell), transmission power of the on-demand SSB (e.g., ss-PBCH-BlockPower), physical cell ID of the on-demand SSB (e.g., physicalCellId), frequency location of the on-demand SSB (e.g., ssbAbsoluteFrequency), or actually transmitted SSB in a burst for the on-demand SSB (e.g., ssb-PositionsInBurst). For another instance, in the higher layer parameters (e.g., ltm-Candidate or ltm-SSB-Config), there can be an explicit indication on whether the associated SSB of the candidate cell is on-demand SSB or not.

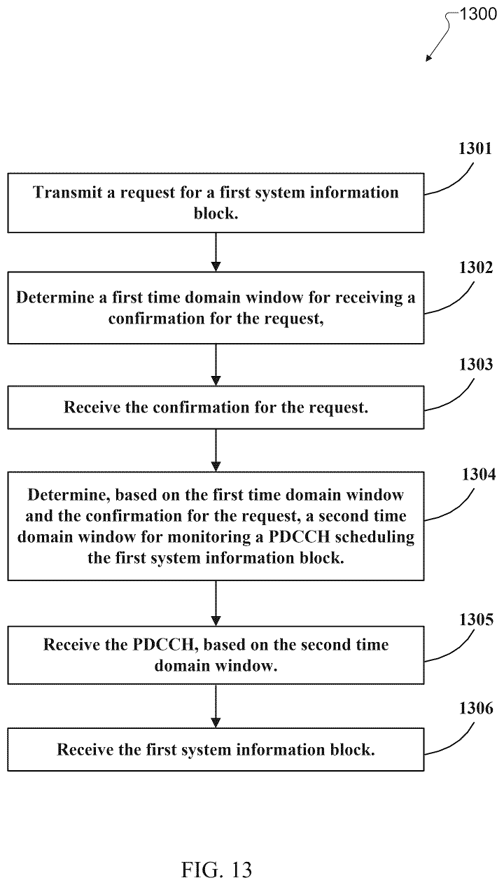

FIG. 13 illustrates an example method 1300 performed by a UE in a wireless communication system according to embodiments of the present disclosure. The method 1300 of FIG. 13 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

The method 1300 begins with the UE transmitting a request for a first system information block (1301). The UE then determines a first time domain window for receiving a confirmation for the request (1302) and receives the confirmation for the request (1303). In various embodiments, the request is based on a PRACH, the confirmation for the request is based on a RAR; and the first time domain window is a RAR window.

The UE then determines, based on the first, time-domain window and the confirmation for the request, a second, time-domain window for monitoring a PDCCH scheduling the first system information block (1304). In various embodiments, a starting slot of the second time domain window is determined as a later slot between a first slot including the confirmation for the request and a second slot that is with a time offset from a starting slot of the first time domain window. In various embodiments, the time offset is provided by a higher layer parameter. In various embodiments, a duration of the second time domain window is provided by a higher layer parameter.

The UE then receives the PDCCH based on the second time domain window (1305) and receives the first system information block (1306). In various embodiments, the UE receives higher layer parameters and determines, based on the higher layer parameters, a second system information block. For example, the second system information block includes a value of k_{SSB}, for determining a frequency offset between the SSB and a common resource block, a configuration for a search space set for the PDCCH, and a configuration for a CORESET for the PDCCH. In various embodiments, the second system information block further includes configurations for a downlink carrier including the first system information block, configurations for an uplink carrier including the request, configurations for the request, configurations for an initial uplink bandwidth part for transmitting the request, at least one physical cell identity, a threshold for a RSRP for a SSB, a periodicity for the SSB, a transmission power for the SSB, an indication of actually transmitted SSBs in a burst, and a configuration for uplink and downlink slot format, applicable for TDD bands.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A base station (BS) in a wireless communication system, the BS comprising:
a transceiver configured to receive a request for a first system information block; and
a processor operably coupled to the transceiver, the processor configured to determine a first time domain window for transmitting a confirmation for the request,
wherein the transceiver is further configured to transmit the confirmation for the request in the first time domain window,
wherein the transceiver is further configured to determine, based on the first time domain window and the confirmation for the request, a second time domain window for monitoring a physical downlink control channel (PDCCH) scheduling the first system information block, and
wherein the transceiver is further configured to:
transmit the PDCCH in the second time domain window; and
transmit the first system information block.

2. The BS of claim 1, wherein:
the request is based on a physical random access channel (PRACH);
the confirmation for the request is based on a random access response (RAR); and
the first time domain window is a RAR window.

3. The BS of claim 1, wherein a starting slot of the second time domain window is determined as a later slot between:
a first slot including the confirmation for the request; and
a second slot that is with a time offset from a starting slot of the first time domain window.

4. The BS of claim 3, wherein the time offset is included a higher layer parameter.

5. The BS of claim 1, wherein a duration of the second time domain window is included in a higher layer parameter.

6. The BS of claim 1, wherein:
the transceiver is further configured to transmit higher layer parameters,
the higher layer parameters include a second system information block, and
the second system information block includes:
a value of k_{SSB}, for determining a frequency offset between the SSB and a common resource block;
a configuration for a search space set for the PDCCH; and
a configuration for a control resource set (CORESET) for the PDCCH.

7. The BS of claim 6, wherein the second system information block further includes:
configurations for a downlink carrier including the system information block;
configurations for an uplink carrier including the request;
configurations for the request;
configurations for an initial uplink bandwidth part for transmitting the request;
at least one physical cell identity;
a threshold for a reference signal received power (RSRP) for a synchronization signal and physical broadcast channel block (SSB);
a periodicity for the SSB;
a transmission power for the SSB;
an indication of actually transmitted SSBs in a burst; and
a configuration for uplink and downlink slot format, applicable for time division duplex (TDD) bands.

8. A user equipment (UE) in a wireless communication system, the UE comprising:
a transceiver configured to transmit a request for a first system information block; and
a processor operably coupled to the transceiver, the processor configured to determine a first time domain window for receiving a confirmation for the request,
wherein the transceiver is further configured to receive the confirmation for the request in the first time domain window,
wherein the processor is further configured to determine, based on the first time domain window and the confirmation for the request, a second time domain window for monitoring a physical downlink control channel (PDCCH) scheduling the first system information block, and
wherein the transceiver is further configured to:
receive the PDCCH based on the second time domain window; and
receive the first system information block.

9. The UE of claim 8, wherein:
the request is based on a physical random access channel (PRACH);
the confirmation for the request is based on a random access response (RAR); and
the first time domain window is a RAR window.

10. The UE of claim 8, wherein a starting slot of the second time domain window is determined as a later slot between:
a first slot including the confirmation for the request; and
a second slot that is with a time offset from a starting slot of the first time domain window.

11. The UE of claim 10, wherein the time offset is provided by a higher layer parameter.

12. The UE of claim 8, wherein a duration of the second time domain window is provided by a higher layer parameter.

13. The UE of claim 8, wherein:
the transceiver is further configured to receive higher layer parameters,
the processer is further configured to determine, based on the higher layer parameters, a second system information block, and
the second system information block includes:
a value of k_{SSB}, for determining a frequency offset between the SSB and a common resource block;
a configuration for a search space set for the PDCCH; and
a configuration for a control resource set (CORESET) for the PDCCH.

14. The UE of claim 13, wherein the second system information block further includes:
configurations for a downlink carrier including the first system information block;
configurations for an uplink carrier including the request;
configurations for the request;
configurations for an initial uplink bandwidth part for transmitting the request;
at least one physical cell identity;
a threshold for a reference signal received power (RSRP) for a synchronization signal and physical broadcast channel block (SSB);
a periodicity for the SSB;
a transmission power for the SSB;
an indication of actually transmitted SSBs in a burst; and
a configuration for uplink and downlink slot format, applicable for time division duplex (TDD) bands.

15. A method of a user equipment (UE) in a wireless communication system, the method comprising:
transmitting a request for a first system information block;
determining a first time domain window for receiving a confirmation for the request;
receiving the confirmation for the request in the first time domain window;
determining, based on the first time domain window and the confirmation for the request, a second time domain window for monitoring a physical downlink control channel (PDCCH) scheduling the first system information block;
receiving the PDCCH based on the second time domain window; and
receiving the first system information block.

16. The method of claim 15, wherein:
the request is based on a physical random access channel (PRACH);
the confirmation for the request is based on a random access response (RAR); and
the first time domain window is a RAR window.

17. The method of claim 15, wherein a starting slot of the second time domain window is determined as a later slot between:
a first slot including the confirmation for the request; and
a second slot that is with a time offset from a starting slot of the first time domain window.

18. The method of claim 17, wherein the time offset is provided by a higher layer parameter.

19. The method of claim 15, wherein a duration of the second time domain window is provided by a higher layer parameter.

20. The method of claim 15, further comprising:
receiving higher layer parameters; and
determining, based on the higher layer parameters, a second system information block, the second system information block including:
a value of k_{SSB}, for determining a frequency offset between the SSB and a common resource block;
a configuration for a search space set for the PDCCH;
a configuration for a control resource set (CORESET) for the PDCCH;
configurations for a downlink carrier including the first system information block;
configurations for an uplink carrier including the request;
configurations for the request;
configurations for an initial uplink bandwidth part for transmitting the request;
at least one physical cell identity;
a threshold for a reference signal received power (RSRP) for a synchronization signal and physical broadcast channel block (SSB);
a periodicity for the SSB;
a transmission power for the SSB;
an indication of actually transmitted SSBs in a burst; and
a configuration for uplink and downlink slot format, applicable for time division duplex (TDD) bands.
